(19) United States
(12) Patent Application Publication
(10) Pub. No.: US 2026/0111338 A1
(43) Pub. Date: Apr. 23, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Rikiya HIRAISHI, Aichi (JP); Tatsumi OBA, Chiba (JP)

(73) Assignee: Panasonic Intellectual Property Management Co., Ltd., Osaka (JP)

(21) Appl. No.: 19/423,783

(22) Filed: Dec. 17, 2025

Related U.S. Application Data
(63) Continuation of application No. PCT/JP2024/018423, filed on May 20, 2024.

(30) Foreign Application Priority Data
Jun. 30, 2023 (JP) 2023-108554

(51) Int. Cl. G06F 11/34; G06F 11/07

(52) U.S. Cl. CPC G06F 11/3476; G06F 11/079

(57) ABSTRACT

An information processing method according to one aspect of the present disclosure is an information processing method executed by a computer, including: obtaining one or more anomaly determination rules to be used in an anomaly determination for a log of a device, each of the one or more anomaly determination rules including a predetermined condition using one or more items among a plurality of items included in the log of the device; determining a priority of each of the plurality of items based on the one or more anomaly determination rules obtained, the priority being a degree for determining an item, among the plurality of items, to be included in a first log to be sent to an analysis device that performs the anomaly determination; and outputting priorities, each being the priority determined.

### CROSS REFERENCE TO RELATED APPLICATIONS

This is a continuation application of PCT International Application No. PCT/JP2024/018423 filed on May 20, 2024, designating the United States of America, which is based on and claims priority of Japanese Patent Application No. 2023-108554 filed on Jun. 30, 2023. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

As factories, buildings, or control systems such as power systems are increasingly being connected to the Internet of Things (IoT) in recent years, cyberattacks are also on the rise. For general Internet Technology (IT) devices, measures against cyberattacks are often taken by introducing security software such as Endpoint Detection and Response (EDR) into the IT devices. However, such measures are difficult for IoT devices, which do not have the abundant resources provided in IT devices. Therefore, as a measure against cyberattacks, IoT devices often send the logs of the IoT devices themselves to an external analysis device in the cloud or the like, and the analysis device then analyzes the logs. Security Information Event Management (SIEM) or EDR can be given as examples of external analysis devices. These analysis devices collect logs from various devices and detect anomalies such as cyberattacks by analyzing the logs in a comprehensive manner.

In a control system in which a large number of IoT devices are installed, the amount of data in a log sent by the control system to an external analysis device (also called simply a “log amount”) expands massively in proportion with the number of IoT devices in the control system. However, the increase in the log amount sent from IoT devices leads to strain on the communication bandwidth, and the collection and analysis of large amounts of log data by the external analysis device leads to an increase in costs. It is therefore necessary to maintain the accuracy of the analysis by the external analysis device while reducing the log amounts sent by the IoT devices.

Patent Literature (PTL) 1, for example, discloses a method in which a rule is shared with IoT devices by an external device in advance, and if a log matches the rule, the IoT device sends the log that matches the rule to the external device. According to the method disclosed in PTL 1, the sending of logs by the IoT devices can be kept to a minimum, and thus the log amounts sent from the IoT devices can be reduced.

### CITATION LIST

### Patent Literature

PTL 1: International Publication No. 2021/171390

### SUMMARY

### Technical Problem

According to the method disclosed in PTL 1, sharing a log sending rule, which indicates conditions of communication data to be included in a log sent by the IoT device to the external device, with the IoT device, makes it possible for the IoT device to use the log sending rule to send only the log optimal for anomaly analysis by the analysis device. This in turn makes it possible to reduce the log amounts sent by IoT devices.

However, log sending rules tailored to the analysis device are necessary to ensure the IoT device will send an optimal log using the log sending rules. In order for an IoT device to use such log sending rules, a method in which an administrator updates the log sending rules, or a method in which the log sending rules are used while switching among a predefined plurality of log sending rules according to the state of the IoT device, is conceivable. However, with such methods, the log sending rules used by the IoT device may not be set optimally in cases such as where the state of the IoT device cannot be clearly defined.

Furthermore, in an analysis device such as SIEM, anomalies to be detected differ depending on the environment of the IoT device, and thus the anomaly determination rules (anomaly detection rules) used by the analysis device increase and decrease. However, for an IoT device to send a log optimal for the analysis device to detect an anomaly, it is necessary for an administrator to manually update the log sending rules according to an increase or decrease of the anomaly determination rules whenever the anomaly determination rules used by the analysis device increase or decrease. Such updating places a high workload on the administrator and is therefore unrealistic.

Accordingly, the present disclosure reduces a data amount of a log sent to an analysis device while maintaining the accuracy of log analysis by the analysis device.

### Solution to Problem

An information processing method according to one aspect of the present disclosure is an information processing method executed by a computer, including: obtaining one or more anomaly determination rules to be used in an anomaly determination for a log of a device, each of the one or more anomaly determination rules including a predetermined condition using one or more items among a plurality of items included in the log of the device; determining a priority of each of the plurality of items based on the one or more anomaly determination rules obtained, the priority being a degree for determining an item, among the plurality of items, to be included in a first log to be sent to an analysis device that performs the anomaly determination; and outputting priorities, each being the priority determined.

An information processing device according to one aspect of the present disclosure includes: an obtainer that obtains one or more anomaly determination rules to be used in an anomaly determination for a log of a device, each of the one or more anomaly determination rules including a predetermined condition using one or more items among a plurality of items included in the log of the device; a determiner that determines a priority of each of the plurality of items based on the one or more anomaly determination rules obtained, the priority being a degree for determining an item, among the plurality of items, to be included in a first log to be sent to an analysis device that performs the anomaly determination; and an outputter that outputs priorities, each being the priority determined.

A recording medium according to one aspect of the present disclosure is a non-transitory computer-readable recording medium having recorded thereon a program for causing a computer to execute an information processing method including: obtaining one or more anomaly determination rules to be used in an anomaly determination for a log of a device, each of the one or more anomaly determination rules including a predetermined condition using one or more items among a plurality of items included in the log of the device; determining a priority of each of the plurality of items based on the one or more anomaly determination rules obtained, the priority being a degree for determining an item, among the plurality of items, to be included in a first log to be sent to an analysis device that performs the anomaly determination; and outputting priorities, each being the priority determined.

### Advantageous Effects

According to the present disclosure, the amount of data in a log sent to an analysis device can be reduced while maintaining the accuracy of log analysis by the analysis device.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating the overall configuration of a log priority calculation system according to an embodiment.

FIG. 2 is a diagram illustrating the overall configuration of a log analysis system according to the embodiment.

FIG. 3 is a diagram illustrating an example of a flowchart of anomaly determination processing according to the embodiment.

FIG. 4 is a diagram illustrating an example of device data according to the embodiment.

FIG. 5 is a diagram illustrating an example of anomaly determination rules used in an anomaly determiner according to the embodiment.

FIG. 6 is a diagram illustrating an example of anomaly determination results according to the embodiment.

FIG. 7 is a diagram illustrating an example of a flowchart of missing column obtainment processing according to the embodiment.

FIG. 8 is a diagram illustrating an example of a flowchart of log priority update processing according to the embodiment.

FIG. 9 is a diagram illustrating a column list stored in log priority storage according to the embodiment.

FIG. 10 is a diagram illustrating an example of a flowchart of log priority calculation processing according to the embodiment.

FIG. 11 is a diagram illustrating an example of a log priority determination process using an anomaly determination result according to the embodiment.

FIG. 12 is a diagram illustrating an example of a flowchart of log priority calculation processing using anomaly determination rules according to Variation 1 on the embodiment.

FIG. 13 is a diagram illustrating an example of a log priority determination process using anomaly determination rules according to Variation 1 on the embodiment.

FIG. 14 is a diagram illustrating an example of a flowchart of log priority calculation processing according to Variation 2 on the embodiment.

FIG. 15 is a diagram illustrating an example of a total data amount per column for a predetermined period according to Variation 2 on the embodiment.

FIG. 16 is a diagram illustrating an example of a log priority determination process using a total data amount per column according to Variation 2 on the embodiment.

FIG. 17 is a flowchart illustrating an information processing method according to the embodiment.

### DESCRIPTION OF EMBODIMENT

### Underlying Knowledge Forming Basis of Present Disclosure

As IoT connections increase in the fields of factories, buildings, or control systems such as power systems, control system networks are increasingly being connected to the Internet to improve convenience and efficiency. As a result, like IT systems, control systems are increasingly at risk of cyberattacks, and the introduction of security measures in control systems is an urgent issue.

Since system uptime is of the utmost importance in a control system, general security measures such as introducing antivirus software or applying security patches are not an easy solution. As such, in a control system, communication logs between devices are often obtained passively and sent to an analysis device such as SIEM to collect and manage the logs centrally and monitor them for signs of cyberattacks.

In addition, as cyberattacks become more sophisticated, general security measures such as introducing antivirus software or applying security patches are becoming inadequate, even in IT environments. The introduction of EDR, which aims to prevent damage by quickly detecting and responding to situations where an attacker infiltrates through a cyberattack, is therefore also increasing.

In a system that uses EDR, an agent is installed inside the device to be monitored, and a log of the device to be monitored (log data) is sent to a server installed in the cloud or the like. In such a configuration, the logs are often analyzed in an integrated manner within the server.

In an analysis device such as SIEM or EDR, anomaly determination rules for analyzing communication logs between devices and internal logs of devices to determine anomalies change over time according to changes in the types of events to be handled or changes in cyberattack trends. Therefore, to enable anomaly determinations using anomaly determination rules that have changed, a device will send all obtained logs to the analysis device to the greatest extent possible.

When the communication volume between devices is large or a large number of devices are present, the amount of logs sent to the analysis device increases as well, which may increase the costs involved in anomaly determination and strain the communication bandwidth. However, there is a risk that the accuracy of the anomaly determination in the analysis device will drop if the logs sent by the device are selected incorrectly, and it is therefore not easy to reduce the amount of logs sent by the device to the analysis device while maintaining the accuracy of the anomaly determination.

Accordingly, an information processing method according to Aspect 1 is an information processing method executed by a computer, including: obtaining one or more anomaly determination rules to be used in an anomaly determination for a log of a device, each of the one or more anomaly determination rules including a predetermined condition using one or more items among a plurality of items included in the log of the device; determining a priority of each of the plurality of items based on the one or more anomaly determination rules obtained, the priority being a degree for determining an item, among the plurality of items, to be included in a first log to be sent to an analysis device that performs the anomaly determination; and outputting priorities, each being the priority determined.

Through this, an optimal priority (also called a “log priority”) according to the content of the anomaly determination rule used in the anomaly determination by the analysis device can be output. For example, the priority is output to a device (also called an “IoT device”). Based on the priority that is output, the device can send the log including an item, among a plurality of items included in the log of the device (also called “device data”), that is necessary for the anomaly determination by the analysis device in the log (the first log). This makes it possible to reduce the volume of logs sent without reducing the accuracy of the anomaly determination by the analysis device. In other words, according to the information processing method of Aspect 1, the amount of data in a log sent to an analysis device can be reduced while maintaining the accuracy of log analysis by the analysis device.

An information processing method according to Aspect 2 is the information processing method according to Aspect 1, wherein the log of the device may be a communication log of the device or an operation log of the device.

Through this, the anomaly determination for the communication log or the operation log of the device can be performed by the analysis device.

An information processing method according to Aspect 3 is the information processing method according to Aspect 1 or Aspect 2, further including storing the priorities determined, wherein the determining of the priorities may be performed every predetermined first period, and the outputting of the priorities may include outputting the priorities determined when any one of the priorities determined for the plurality of items has changed from a corresponding one of the priorities stored for the plurality of items.

Through this, the log priority can be output only when the priority changes, which makes it possible to reduce the volume of communication with the information processing device that executes the information processing method of Aspect 3.

An information processing method according to Aspect 4 is the information processing method according to Aspect 3, wherein the outputting of the priorities may include outputting only the priority, among the priorities determined for the plurality of items, of an item for which the priority has changed from the corresponding one of the priorities stored for the plurality of items.

Through this, the volume of communication between the device and the information processing device that executes the information processing method of Aspect 4 can be further reduced.

An information processing method according to Aspect 5 is the information processing method according to any one of Aspect 1 to Aspect 4, further including storing the one or more anomaly determination rules obtained, wherein the determining of the priorities may be performed when at least one of the one or more anomaly determination rules obtained again has changed from the one or more anomaly determination rules stored.

Through this, when the anomaly determination rule changes, a priority corresponding to the change in the anomaly determination rule can be output. This makes it possible to maintain the accuracy of the anomaly determination by the analysis device, and to reduce the volume of communication between the device and the information processing device that executes the information processing method of Aspect 5.

An information processing method according to Aspect 6 is the information processing method according to any one of Aspect 1 to Aspect 5, wherein the priority may be one degree among at least two levels of degrees including a degree indicating that each of the plurality of items is to be included in the first log and a degree indicating that each of the plurality of items is not to be included in the first log.

Through this, the device can send the first log having preferentially included therein an item for which the priority indicating inclusion in the log has been determined, which makes it possible to reduce the volume of logs to be sent while maintaining the accuracy of the anomaly determination by the analysis device.

An information processing method according to Aspect 7 is the information processing method according to Aspect 6, wherein the determining of the priority may include determining the priority to be a degree indicating that the priority of at least one item, among the one or more items used in the predetermined condition to be included in each of the one or more anomaly determination rules obtained, is to be included in the first log.

Through this, the device can send the first log having included therein only the minimum number of items needed to make the anomaly determination using each anomaly determination rule, which makes it possible to reduce the amount of data in the first log (the volume of the log) that the device sends to the analysis device.

An information processing method according to Aspect 8 is the information processing method according to Aspect 6 or Aspect 7, wherein the analysis device may classify a plurality of first logs, each being the first log, into a plurality of groups using a predetermined item, and perform the anomaly determination for each of the plurality of groups, and the determining of the priority may include determining the priority to be a degree indicating that the priority of the predetermined item is to be included in the first log.

Through this, the device can send the first log having included therein only the minimum number of items necessary for the anomaly determination, which makes it possible to reduce the volume of logs that the device sends to the analysis device.

An information processing method according to Aspect 9 is the information processing method according to any one of Aspect 1 to Aspect 8, further including obtaining a determination result of the anomaly determination for the first log, the anomaly determination being executed using the one or more anomaly determination rules, wherein the determining of the priority may include determining the priority based on the determination result.

Through this, even if a trend in cyberattacks or a trend in the logs changes over time, a priority corresponding to the change can be determined and output based on the determination result of the anomaly determination. This makes it possible to maintain the accuracy of the anomaly determination by the analysis device.

An information processing method according to Aspect 10 is the information processing method according to Aspect 9, wherein the determination result may include one or more results, each indicating whether the predetermined condition in a corresponding one of the one or more anomaly determination rules is satisfied, for each of the one or more items to be included in the first log. Additionally, the determining of the priority may include: calculating a matching rate for each of the one or more items, the matching rate being a percentage of the one or more results determined to satisfy the predetermined condition; and determining the priority such that an item, among the one or more items, having a low matching rate has a high degree indicating the item is to be included in the first log.

The analysis device may request the device to send additional information if an item satisfying a predetermined condition included in the anomaly determination rule, i.e., a predetermined condition set by the anomaly determination rule, is not included in the first log. As such, according to the information processing method of Aspect 10, the device can send the first log having preferentially included therein an item having a low matching rate, i.e., an item having a low likelihood of satisfying the predetermined condition set by the anomaly determination rule. This makes it possible to reduce the number of times the analysis device requests the device to send additional information, and to reduce the volume of communication between the device and the analysis device.

An information processing method according to Aspect 11 is the information processing method according to any one of Aspect 1 to Aspect 8, wherein the one or more anomaly determination rules may be a plurality of anomaly determination rules. Additionally, the determining of the priority may include: calculating a usage rate for each of the plurality of items, the usage rate being a percentage of the plurality of anomaly determination rules using each of the plurality of items, and determining the priority such that an item, among the plurality of items, having a high usage rate has a high degree indicating the item is to be included in the first log.

The analysis device may request the device to send additional information if an item determined as the subject of a predetermined condition in the anomaly determination rule is not included in the first log. As such, according to the information processing method of Aspect 11, the device can send the first log having preferentially included therein an item having a high usage rate, i.e., an item determined as the subject of a predetermined condition in more anomaly determination rules. This makes it possible to reduce the number of times the analysis device requests the device to send additional information, and to reduce the volume of communication between the device and the analysis device.

An information processing method according to Aspect 12 is the information processing method according to any one of Aspect 1 to Aspect 8, further including obtaining a second log including all of the plurality of items every predetermined second period, wherein the determining of the priority may include determining the priority based on a total amount of data in each of the plurality of items included in the second log obtained.

Through this, the device can send the first log having preferentially included therein an item having a low total amount of data among the plurality of items included in the log of the device (i.e., the log recorded by the device). This makes it possible to reduce the amount of data (total volume) of the first log to be sent.

An information processing device according to Aspect 13 includes: an obtainer that obtains one or more anomaly determination rules to be used in an anomaly determination for a log of a device, each of the one or more anomaly determination rules including a predetermined condition using one or more items among a plurality of items included in the log of the device; a determiner that determines a priority of each of the plurality of items based on the one or more anomaly determination rules obtained, the priority being a degree for determining an item, among the plurality of items, to be included in a first log to be sent to an analysis device that performs the anomaly determination; and an outputter that outputs priorities, each being the priority determined.

Through this, the information processing device can output, to the device, a priority that is optimal according to the content of the anomaly determination rule used in the anomaly determination by the analysis device. Based on the priority that is output, the device can include an item, among a plurality of items included in the log of the device, that is necessary for the anomaly determination by the analysis device in the first log and send the item to the analysis device. As such, according to the information processing device, the amount of data in a log sent to an analysis device can be reduced while maintaining the accuracy of log analysis by the analysis device.

A program according to Aspect 14 is a program for causing a computer to execute an information processing method including: obtaining one or more anomaly determination rules to be used in an anomaly determination for a log of a device, each of the one or more anomaly determination rules including a predetermined condition using one or more items among a plurality of items included in the log of the device; determining a priority of each of the plurality of items based on the one or more anomaly determination rules obtained, the priority being a degree for determining an item, among the plurality of items, to be included in a first log to be sent to an analysis device that performs the anomaly determination; and outputting priorities, each being the priority determined.

Through this, an optimal priority according to the content of the anomaly determination rule used in the anomaly determination by the analysis device can be output. Based on the priority that is output, the device can include an item, among a plurality of items included in the log of the device, that is necessary for the anomaly determination by the analysis device in the first log and send the item. As such, according to the computer that executes the program of Aspect 14, the amount of data in the log sent to the analysis device can be reduced while maintaining the accuracy of log analysis by the analysis device.

Embodiments of the present disclosure will be described in detail below with reference to the accompanying drawings. The following embodiments describe specific examples of the present disclosure. The numerical values, shapes, constituent elements, steps, orders of steps, and the like in the following embodiments are merely examples, and are not intended to limit the present disclosure. Additionally, of the constituent elements in the following embodiments, constituent elements not denoted in the independent claims will be described as optional constituent elements. Additionally, in all of the embodiments and variations, individual details can be combined.

Note that the same reference signs are used for the same constituent elements in the drawings.

In addition, in the present specification, unless otherwise specified, ordinals such as “first” and “second” do not refer to the number or order of the constituent elements, and are rather used for the purpose of avoiding confusion and distinguishing between constituent elements of the same kind.

As used here, descriptions such as “at least a threshold” or “lower than a threshold” indicate that the distinction is made at the threshold itself, and such descriptions may also be taken as meaning “greater than the threshold” or “not greater than the threshold,” respectively.

Numerical values such as thresholds in the embodiment are all examples, and may be other numerical values.

### Embodiment

### Overall Configuration

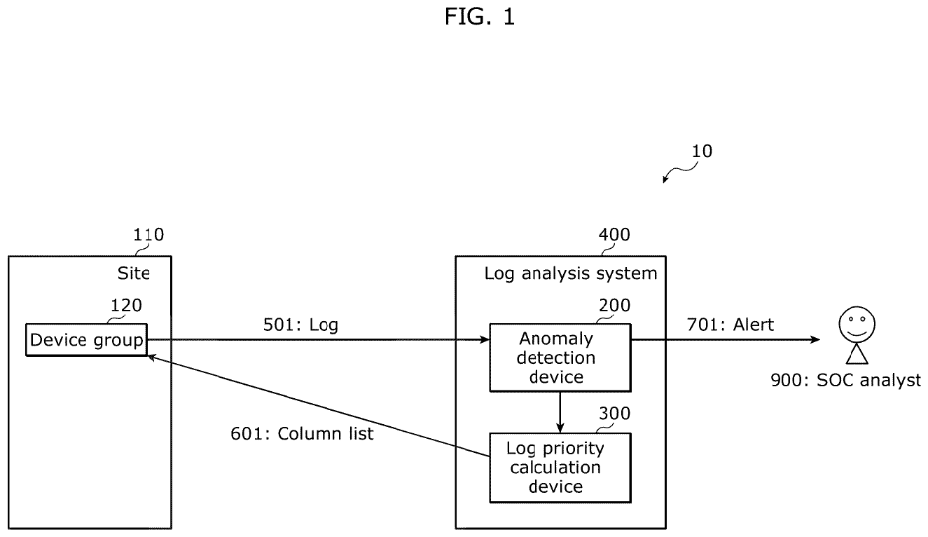

FIG. 1 is a diagram illustrating the overall configuration of an example of log priority calculation system 10 according to the present embodiment.

Log priority calculation system 10 is a system that analyzes logs sent from a device such as an IoT device based on a log priority (also called simply a “priority”) and notifies a user of an analysis result. Log priority calculation system 10 includes device group 120 and log analysis system 400, for example.

Device group 120 includes at least one device such as an IoT device. For example, device group 120 is provided in site 110, which is a structure such as a factory or building. In other words, device group 120 constituted by a plurality of devices is present at site 110. Any devices may be included in device group 120, such as Office Automation (OA) devices in an IT environment, controllers in a control system environment, IP cameras (network cameras), or the like.

Each of the plurality of devices included in device group 120 (also called simply “device group 120” hereinafter) sends a log internal to the device itself (i.e., a processing log indicating processing executed by the device itself) and a log of communication data from communication performed with other devices (also called a “communication log”) (the logs will also be called “device data”) to log analysis system 400 as log 501. Specifically, each device included in device group 120 records information indicating the operations of the device itself as the device data, and sends at least some of the information in the recorded device data to log analysis system 400 as log 501. The device data is an example of a log of a device, and log 501 is an example of a first log. For example, the log of the device (the device data) is a communication log of the device or an operation log of the device.

Note that when devices included in device group 120 communicate, only one of the devices involved in the communication may send the communication log to log analysis system 400 as log 501. Additionally, each device may send only communication logs sent to other devices, or communication logs received from other devices, as log 501. Additionally, any one of the plurality of devices included in device group 120 may collect log 501 of each device and send the collected logs 501 to log analysis system 400 on behalf of device group 120.

Log analysis system 400 is a system that analyzes log 501 sent from device group 120. Log analysis system 400 includes anomaly detection device 200 and log priority calculation device 300.

Anomaly detection device 200 is a computer that receives log 501 sent from device group 120 and determines an anomaly in log 501 received (anomaly determination processing). Here, when an anomaly is detected in log 501, anomaly detection device 200 notifies SOC analyst 900, who analyzes the anomaly in a Security Operation Center (SOC), of alert 701 for communicating the anomaly. Through this, SOC analyst 900 analyzes a cyberattack. Anomaly detection device 200 is an example of an analysis device.

Log priority calculation device 300 is a computer that determines a log priority, which is a priority of an item to be sent to log analysis system 400 by device group 120 from among a plurality of items (types) included in the device data. For example, log priority calculation device 300 obtains necessary information such as analysis rules and analysis results from anomaly detection device 200 periodically, e.g., about once a day, generates column list 601 based on the information obtained, and sends column list 601 generated to device group 120 at site 110. Log priority calculation device 300 is an example of an information processing device.

Column list 601 is information including the log priority, which indicates a degree to which an item to be included in log 501 is to be determined from among the plurality of items included in the device data recorded by device group 120. Column list 601 and the log priority will be described in greater detail later.

Upon receiving column list 601 from log priority calculation device 300, device group 120 selects an item to be sent as log 501 according to column list 601 received, and sends log 501 including the item selected (specifically, log 501 including a value corresponding to the item) to anomaly detection device 200.

Anomaly detection device 200 and log priority calculation device 300 are both implemented by a communication interface, a non-volatile memory in which programs are stored, a volatile memory serving as a temporary storage region for executing the programs, input/output ports for sending and receiving signals, a processor that executes the programs, and the like. Each communication interface may be implemented by, for example, an antenna and a wireless communication circuit enabling wireless communication, or by a connector or the like to which a communication line is connected to enable wired communication.

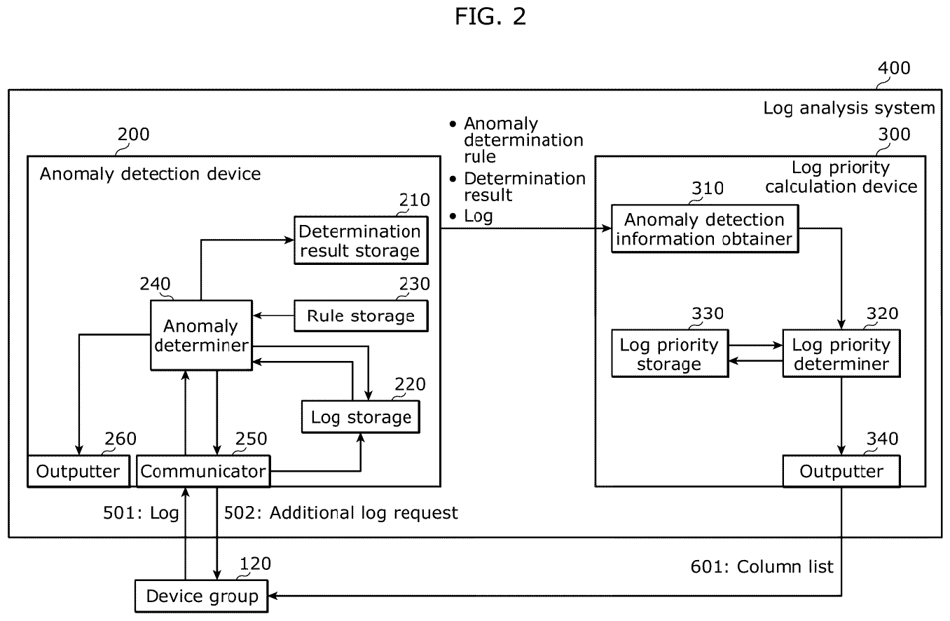

FIG. 2 is a diagram illustrating the overall configuration of log analysis system 400 according to the present embodiment. In FIG. 2, log analysis system 400 is constituted by anomaly detection device 200 and log priority calculation device 300.

Anomaly detection device 200 includes determination result storage 210, log storage 220, rule storage 230, anomaly determiner 240, communicator 250, and outputter 260.

Rule storage 230 is a storage device that stores one or more anomaly determination rules for anomaly determiner 240 to determine an anomaly in log 501.

Anomaly determiner 240 is a processing unit that performs anomaly determination for log 501 received through communicator 250 based on the one or more anomaly determination rules stored in rule storage 230.

Each of the one or more anomaly determination rules is a rule including a predetermined condition using one or more items among a plurality of items included in the log of the device. In other words, the anomaly determination rule is a rule for determining whether one or more items (and specifically, a value corresponding to the item) satisfy a predetermined condition. For example, the predetermined conditions included in the anomaly determination rules are different from each other, and at least one of the one or more items used in each anomaly determination rule is different from the others. The predetermined condition is, for example, an item included in Condition (described later).

Determination result storage 210 is a storage device that stores a determination result indicating whether an anomaly is present in log 501, determined by anomaly determiner 240.

Communicator 250 is a communication interface for receiving log 501 from device group 120 at site 110 and communicating (sending) log 501 to anomaly determiner 240. If an anomaly determination cannot be made using only log 501 received, anomaly determiner 240 obtains log 501 including items necessary for anomaly determination from device group 120 by sending additional log request 502, which is information requesting an additional log from device group 120 for making an anomaly determination, to device group 120 at site 110 through communicator 250.

Log storage 220 is a storage device that stores log 501 for which an anomaly determination has been made by anomaly determiner 240.

Outputter 260 is a user interface (UI) that outputs a determination result of the anomaly determination made by anomaly determiner 240 for log 501, and alert 701 output when an anomaly is determined to be present in log 501. Note that the determination result and alert 701 may be communicated to SOC analyst 900 using a tool such as email, and may be displayed on a display device such as a display provided in a computer or mobile terminal used by SOC analyst 900. In this case, outputter 260 may be a processing unit that sends the determination result and alert 701 to a computer or mobile terminal used by SOC analyst 900 through communicator 250.

Processing units such as anomaly determiner 240 are implemented by, for example, a processor that executes a control program and a memory that stores the control program.

The storage devices such as determination result storage 210, log storage 220, and rule storage 230 are implemented by a Hard Disk Drive (HDD), a Solid State Drive (SSD), or the like, for example. Note that the storage devices such as determination result storage 210, log storage 220, and rule storage 230 may be implemented by a single shared storage device, or by individual storage devices.

Note that communicator 250 may include a wired communication interface, or a wireless communication interface. Communicator 250 may also include processing units such as a memory and a processor for sending and receiving various types of information.

When outputter 260 is realized by a UI, the UI may be a display device such as a display that displays images expressing the determination result and alert 701, or may be a speaker or the like that outputs the determination result and alert 701 as audio.

Log priority calculation device 300 includes anomaly detection information obtainer 310, log priority determiner 320, log priority storage 330, and outputter 340.

Anomaly detection information obtainer 310 is a processing unit that obtains information necessary for determining the priority (also called the “log priority”) of an item included by device group 120 in log 501 sent by device group 120, obtaining the information from anomaly detection device 200 periodically through batch processing, through a communication interface or the like (not shown) of log priority calculation device 300. In this manner, the log priority is a degree for determining an item, among a plurality of items, to be included in log 501 sent to anomaly detection device 200 that makes an anomaly determination. Specifically, the log priority is information indicating an item, among the plurality of items included in the device data, to be preferentially included in log 501 sent by the device to anomaly detection device 200. For example, the device includes, in log 501, a predetermined number of items, among the plurality of items, in order from the item having the highest priority, and sends log 501 to anomaly detection device 200.

For example, the log priority has degrees of at least two levels, namely a degree indicating that device group 120 is to include each of the plurality of items in log 501, and a degree indicating that device group 120 is not to include each of the plurality of items in log 501. To rephrase, the log priority is, for example, one degree among at least two levels of degrees including a degree indicating that device group 120 is to include each of the plurality of items included in device data in log 501 and a degree indicating that device group 120 is not to include each of the plurality of items included in device data in log 501. In other words, the log priority indicates, for example, that (i) device group 120 is to include the value of an item in log 501 or (ii) device group 120 is not to include the value of the item in log 501. The log priority indicating that device group 120 is to include the value of the item in log 501 is a Priority of 0, for example (described later). The log priority indicating that device group 120 is not to include the value of the item in log 501 is a Priority of 1, for example (described later).

For example, log priority determiner 320 determines the log priority to be a degree indicating that device group 120 is to include the item in log 501, for the log priority of at least one item among one or more items used in a predetermined condition included in each of the one or more anomaly determination rules used by anomaly detection device 200.

Anomaly detection information obtainer 310 communicates information obtained through a communication interface (not shown) included in log priority calculation device 300 to log priority determiner 320, for example. In the batch processing, for example, anomaly detection device 200 sends information such as anomaly determination rules (specifically, information indicating the anomaly determination rules), determination results (specifically, information indicating determination results), and logs received from device group 120 to log priority calculation device 300. In this manner, for example, anomaly detection information obtainer 310 obtains one or more anomaly determination rules or the like used in anomaly determination for the log of a device. Anomaly detection information obtainer 310 is an example of an obtainer.

Note that anomaly detection information obtainer 310 may request anomaly detection device 200 to send the information such as anomaly determination rules, determination results, and logs received from device group 120. For example, anomaly detection information obtainer 310 sends request information to anomaly detection device 200, requesting anomaly detection device 200 to send this information. For example, anomaly detection device 200 sends this information to log priority calculation device 300 when the request information is received. Anomaly detection information obtainer 310 may obtain this information in such a manner.

The information necessary for determining the log priority is at least one of, for example, an anomaly determination rule stored in rule storage 230, a determination result of the anomaly determination made by anomaly determiner 240 every predetermined period, and log 501 stored in log storage 220 every predetermined period.

Note that anomaly detection information obtainer 310 may perform processing such as extracting only information used by log priority determiner 320 to determine the log priority from the obtained information (information shaping processing), and may then send the extracted information to log priority determiner 320.

Log priority determiner 320 is a processing unit that determines the log priority for each of the plurality of items included in the log recorded by device group 120 based on the information obtained by anomaly detection information obtainer 310. For example, log priority determiner 320 determines the priority of each of the plurality of items based on one or more anomaly determination rules obtained by anomaly detection information obtainer 310. Log priority determiner 320 generates column list 601 including information indicating the log priority determined. Log priority determiner 320 is an example of a determiner.

For example, log priority determiner 320 determines the log priority every predetermined period (a first period).

For example, log priority determiner 320 determines the priority based on a determination result of the anomaly determination for log 501, executed by anomaly detection device 200 using the one or more anomaly determination rules (an anomaly determination result, described later). For example, anomaly detection information obtainer 310 obtains the determination result of the anomaly determination for log 501 executed using the one or more anomaly determination rules. The determination result includes, for example, a result of determining whether each of the one or more items included in log 501 satisfies the predetermined condition included in each of the one or more anomaly determination rules. For example, based on the determination result obtained by anomaly detection information obtainer 310, log priority determiner 320 determines the priority of each of the plurality of items included in the device data (specifically, the priority of each of the one or more items included in log 501). Note that for items that are included in the device data but are not used in the determination using the anomaly determination rules, the priority need not be determined, or the priority may be determined to indicate that device group 120 is not to include the items in log 501.

Log priority storage 330 is a storage device that stores the log priority determined by log priority determiner 320. Specifically, log priority storage 330 stores column list 601 generated by log priority determiner 320.

Outputter 340 is a processing unit that outputs the log priority to device group 120. Specifically, outputter 340 sends column list 601 including information indicating the log priority to device group 120 through a communication interface (not shown) included in log priority calculation device 300. For example, if column list 601 generated by log priority determiner 320 has changed from the most recent column list 601 among past column lists 601 stored in log priority storage 330, outputter 340 sends column list 601 generated by log priority determiner 320 to device group 120 at site 110 through the communication interface (not shown) included in log priority calculation device 300. In other words, outputter 340 outputs the log priority determined by log priority determiner 320 this time if any of the log priorities of the plurality of items, determined by log priority determiner 320, has changed from the log priorities of the plurality of items determined previously and stored in log priority storage 330. Thus, for example, log priority calculation device 300 stores the determined priority, the priority determination is made every predetermined first period, and the outputting of the priority includes outputting the determined priority if any of the priorities determined for the plurality of items has changed from the priority stored for the corresponding one of plurality of items. Outputter 340 is an example of an outputter.

For example, outputter 340 outputs only the log priority for an item that has changed. Specifically, outputter 340 outputs only the priority of an item for which the priorities of each of the plurality of items determined by log priority determiner 320 have changed from the priorities of the corresponding plurality of items stored in log priority storage 330. Of course, outputter 340 may output all log priorities determined this time if there is a change in the log priorities.

Note that the communication interface (not shown) included in log priority calculation device 300 may be a wired communication interface or a wireless communication interface, as long as the interface is capable of communication with anomaly detection device 200.

### Processing Sequence

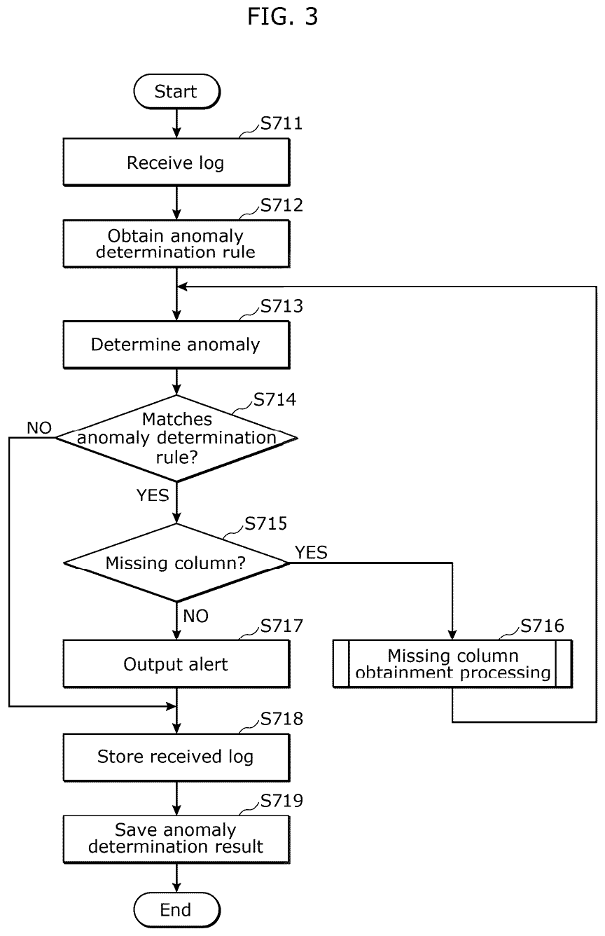

FIG. 3 is a flowchart illustrating an example of anomaly determination processing executed by anomaly detection device 200 according to the present embodiment.

(S711) Communicator 250 of anomaly detection device 200 receives log 501 from device group 120. Log 501 received is stored in log storage 220.

Log 501 sent from device group 120 will be described in detail here.

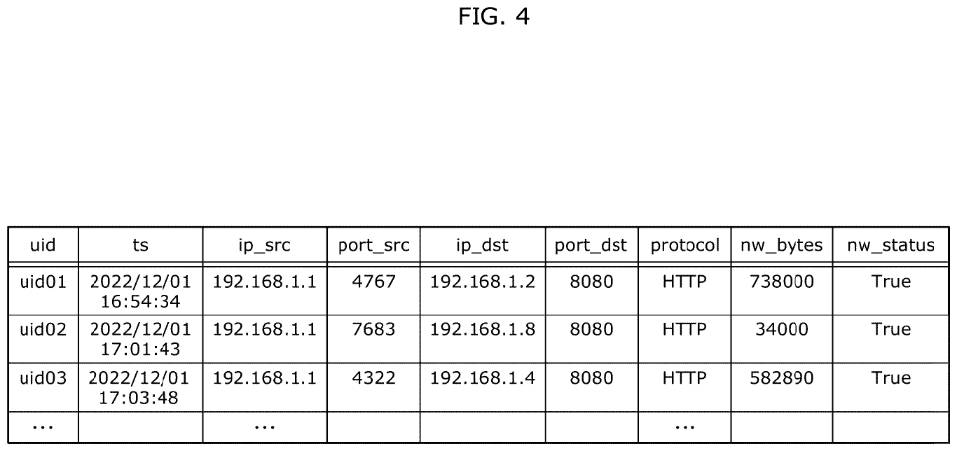

FIG. 4 is a diagram illustrating an example of the device data according to the present embodiment. Specifically, FIG. 4 is a diagram illustrating an example of a communication log of device group 120, which is one item of the device data recorded by device group 120 according to the present embodiment.

In FIG. 4, the device data includes a plurality of items, i.e., columns, that constitute the communication log. Each of the three communication logs illustrated as examples in FIG. 4 includes nine columns, namely “uid”, “ts”, “ip_src”, “port_src”, “ip_dst”, “port_dst”, “protocol”, “nw_bytes”, and “nw_status”. In the following, the columns will be described as referring to the items constituting the communication log.

“uid” is a column (item) indicating an identifier for uniquely identifying the communication log.

“ts” is a column indicating the date/time at which the communication was observed.

“ip_src” is a column indicating the source IP address of the sending device.

“port_src” is a column indicating the source port number of the sending device.

“ip_dst” is a column indicating the destination IP address of the destination device.

“port_dst” is a column indicating the destination port number of the destination device.

“protocol” is a column indicating the type of the protocol in the communication performed by the sending device with the destination device.

“nw_bytes” is a column indicating the communication volume in the communication performed by the sending device with the destination device.

“nw_status” is a column indicating a status of whether the communication performed by the sending device with the destination device was successful.

For example, in FIG. 4, of the three communication logs, the communication log identified by “uid01” indicates that at time “2022/12/01 16:54:34”, that communication of 738,000 bytes was performed using the HTTP protocol from a source IP address 192.168.1.1 and a source port number 4767 to a destination IP address 192.168.1.2 and a destination port number 8080, and that the nw_status is “True”, i.e., the communication was successful.

Note that the combination of the columns included in the communication log illustrated in FIG. 4 is merely an example, and other columns may be included. Additionally, the device data may include not only communication logs in device group 120, but also a logs pertaining to operations of the devices (operation logs) or the like. An operation log is a log including a plurality of columns indicating information pertaining to operations of the device, such as event tasks, dates/times, sources, or the like, exchanged in an operating system of a computer included in the device, for example.

For example, one or more columns are selected from such a plurality of columns, values of the selected one or more columns are included in log 501, and log 501 is sent to anomaly detection device 200.

The descriptions will return to the anomaly determination processing illustrated in FIG. 3.

(S712) Anomaly determiner 240 obtains anomaly determination rules stored in rule storage 230.

The anomaly determination rules will be described in detail here.

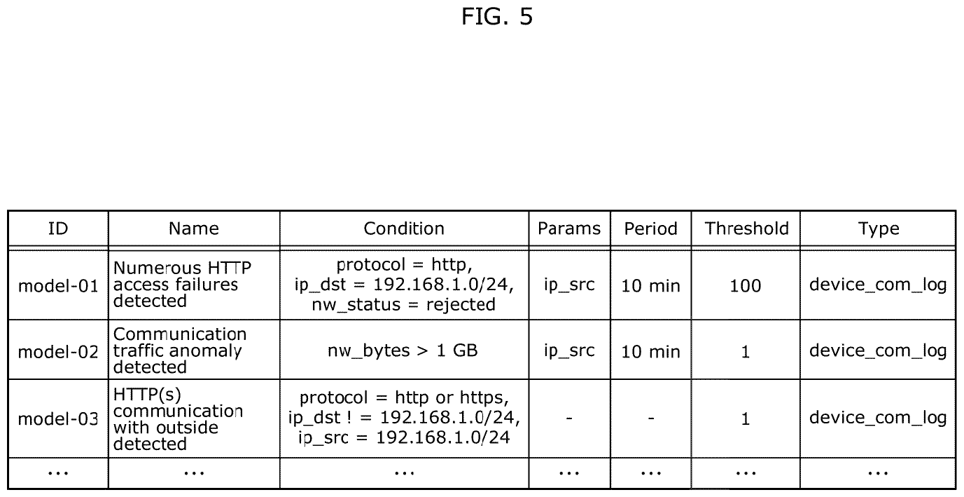

FIG. 5 is a diagram illustrating an example of anomaly determination rules used by anomaly determiner 240 for anomaly determination in log 501 according to the present embodiment.

FIG. 5 illustrates three anomaly determination rules, namely “model-01”, “model-02”, and “model-03”. Each anomaly determination rule includes “ID”, “Name”, “Condition”, “Params”, “Period”, “Threshold”, and “Type”.

“ID” indicates an identifier of the anomaly determination rule.

“Name” indicates a name of the anomaly determination rule.

“Condition” indicates a condition for anomaly determination for the column included in log 501 (also called a “first condition”). The condition for anomaly determination includes, for example, the type of the at least one determination target column that is a column included in log 501 for which the anomaly determination is to be made, and the condition in the at least one determination target column.

“Params” indicates aggregation parameters for anomaly detection device 200 to make an anomaly determination. Specifically, “Param” is a column used for aggregating (classifying) a plurality of logs 501 when the anomaly determination is made. Anomaly detection device 200 classifies the plurality of logs 501 for each log 501 for which the value in the column indicated by the aggregation parameter is the same to create a set of logs 501 for which the values in that column are the same.

“Period” indicates an aggregation period of the aggregation parameters.

“Threshold” indicates a condition under which anomaly detection device 200 determines an anomaly (also called a “second condition”). Specifically, “Threshold” indicates a threshold for the number (total number) of logs 501 for which anomaly detection device 200 determines an anomaly. For example, anomaly detection device 200 determines whether, of one or more logs 501 included in a predetermined set to which the plurality of logs 501 aggregated (received) during the aggregation period belong, a total number of logs 501 that match the condition indicated by “Condition” (the first condition) is at least the threshold indicated by “Threshold”, i.e., whether the second condition is satisfied. Anomaly detection device 200 determines that an anomaly is present in log 501 when the total number is determined to be at least the threshold. In other words, in this case, anomaly detection device 200 determines that some problem has occurred in the device that sent log 501 used to determine the anomaly, such as being under a cyberattack. On the other hand, anomaly detection device 200 determines that no anomaly is present when the total number is determined to be less than the threshold. In other words, in this case, anomaly detection device 200 determines that the device that sent log 501 used to determine the anomaly is normal. The first condition and the second condition are examples of predetermined conditions. In this manner, the predetermined condition is a condition in which one or more items are used.

“Type” indicates a log type to which the anomaly determination rule is to be applied.

Although the “Type” of each anomaly determination rule indicated in FIG. 5 is a log type indicated by “device_com_log”, the type is not limited thereto. “Type” can include a plurality of log types, such as a DNS query information log or an HTTP request log. For example, of the plurality of logs 501 sent from device group 120, logs 501 having different log types can include different types of columns. In the present embodiment, log 501 indicated by the log type “device_com_log” is a log of communication in device group 120, and is data such as that illustrated in FIG. 4.

For example, in FIG. 5, an anomaly determination rule having an ID of “model-01” is an anomaly determination rule for determining an anomaly of “numerous HTTP access failures detected” for log 501 having a log type of “device_com_log”. Additionally, in that anomaly determination rule, the aggregation parameter is “ip_src” (source IP address), the aggregation period is 10 minutes, and the threshold is 100 items. In other words, when logs 501 are aggregated for each of the plurality of ip_src values included in the plurality of logs 501, an anomaly is determined when, of aggregated logs 501 indicating the same value for “ip_src”, the number of logs 501 matching “protocol=http, ip_dst=192.168.1.0/24, nw_status=rejected” is at least 100 in a span of 10 minutes. This anomaly determination is performed for each set of logs 501 in which the value of ip_src is the same.

The descriptions will return to the anomaly determination processing illustrated in FIG. 3.

(S713) For the one or more logs 501 stored in log storage 220 in the predetermined period (the first period), anomaly determiner 240 performs an anomaly determination, including a determination of whether log 501 satisfies the first condition indicated in “Condition” included in the anomaly determination rule obtained in step S712 (also called a “first determination”) and a determination of whether the number of logs 501 satisfying the first condition is greater than the threshold indicated in “Threshold” included in the anomaly determination rule (also called a “second determination”). Specifically, when, among the one or more logs 501 from the predetermined period stored in log storage 220, logs 501 for which the log type matches the type indicated by “Type” in the anomaly determination rule are aggregated (classified) according to the aggregation parameters indicated by “Params” in the anomaly determination rule, anomaly determiner 240 determines whether the columns included in logs 501 satisfy the condition indicated in “Condition” of the anomaly determination rule. Furthermore, anomaly determiner 240 determines whether the number of logs 501 satisfying the condition is greater than the threshold indicated in “Threshold” of the anomaly determination rule within the aggregation period.

Note that in if the aggregation parameters are not included in the anomaly determination rule, anomaly determiner 240 performs the anomaly determination for all of the one or more logs 501 obtained during the predetermined period. Furthermore, if the aggregation period is not included in the anomaly determination rule, anomaly determiner 240 only determines whether the number of logs 501 satisfying the condition is greater than the threshold, regardless of the aggregation period.

Note that the predetermined period may be set as desired, and is not particularly limited. For example, the predetermined period and the aggregation period may be the same period or may be different periods.

For example, when making an anomaly determination based on the anomaly determination rule indicated by the ID of “model-02” for the plurality of logs 501 having the log type “device_com_log”, anomaly determiner 240 first aggregates logs 501 for each value of “ip_src” in the aggregation parameters. Then, anomaly determiner 240 determines, for the aggregated logs 501, whether at least one log 501, indicated by the threshold, that satisfies the condition “nw_bytes>1 GB” indicated in “Condition” is present during the 10 minutes indicated as the aggregation period. For example, when the “nw_bytes” column of a given log 501 is “nw_bytes=1.2 GB”, anomaly determiner 240 determines that the condition indicated in “Condition” is satisfied, i.e., that the first condition is satisfied.

If, in the conditions indicated in “Condition”, a plurality of types of columns are indicated as determination target columns, anomaly determiner 240 determines whether the determination target columns satisfy the conditions. For example, consider a case where, when the “protocol”, “ip_dst”, and “nw_status” columns included in log 501 are “protocol=http, ip_dst=192.168.1.0/24, nw_status=true”, anomaly determiner 240 determines the anomaly using the anomaly determination rule indicated by the ID “model-01”. In this case, compared to the conditions indicated in “Condition” included in the anomaly determination rule, the columns of “protocol” and “ip_dst” match the conditions indicated in the anomaly determination rule, but the column of “nw_status” does not match the conditions. Accordingly, anomaly determiner 240 determines that, because all of the conditions are not satisfied, log 501 does not meet the conditions indicated in “Condition”, i.e., does not satisfy the first condition.

Note that if a plurality of anomaly determination rules are present, anomaly determiner 240 performs the same anomaly determination similar as above for all anomaly determination rules. In this case, if the number of logs 501 determined to satisfy the condition indicated by any anomaly determination rule is greater than the threshold within the aggregation period, anomaly determiner 240 determines a match with the anomaly determination rule, i.e., that an anomaly is present. Additionally, anomaly determinations based on different anomaly determination rules may be executed in parallel, or may be executed sequentially in any order.

If, among the plurality of determination target columns indicated in the anomaly determination rule, some of the determination target columns are not included in log 501, anomaly determiner 240 makes the determination for the other determination target columns aside from the stated some of the determination target columns. In this case, if all of the other determination target columns, aside from the partial determination target column, match the condition indicated in the anomaly determination rule, anomaly determiner 240 determines that the anomaly matches the anomaly determination rule.

For example, consider a case where an anomaly determination is made for log 501 that includes four columns, namely “protocol”, “ip_src”, “nw_status”, and “nw_bytes”. According to the anomaly determination rule having an ID of “model-02”, the determination target columns include the “nw_bytes” column. On the other hand, each of the anomaly determination rule having an ID of “model-01” and the anomaly determination rule having an ID of “model-03” includes a column of “ip_dst” in the determination target columns. However, “ip_dst” is not included in log 501 in the above case. Accordingly, when making an anomaly determination for such log 501, if the anomaly determination is made using each of the anomaly determination rule having an ID of “model-01” and the anomaly determination rule having an ID of “model-03”, anomaly determiner 240 makes the determination for the “protocol”, “ip_src”, and “nw_status” columns, which are the determination target columns, excluding “ip_dst”.

(S714) Anomaly determiner 240 confirms whether the one or more logs 501 for the determination match the anomaly determination rule as a result of executing the anomaly determination for log 501 in step S713. In other words, anomaly determiner 240 determines whether the one or more logs 501 for the determination satisfy the second condition as a result of the second determination. If anomaly determiner 240 determines that one or more logs 501 match the anomaly determination rule (YES in step S714), the sequence moves to step S715. However, if anomaly determiner 240 determines that all of the one or more logs 501 do not match the anomaly determination rule (NO in step S714), the sequence moves to step S718.

(S715) Anomaly determiner 240 determines whether all of the determination target columns indicated in the anomaly determination rule were included in log 501 when making the anomaly determination using the anomaly determination rule for log 501 in step S713. In other words, anomaly determiner 240 determines whether log 501 does not include all of the determination target columns indicated in the anomaly determination rule and a column is missing (also simply called a “missing column”). For example, if anomaly determiner 240 determines that “ip_dst” among the determination target columns in the anomaly determination rule is not included in log 501 and makes the determination for the other determination target columns aside from “ip_dst”, a missing column is determined to be present. If anomaly determiner 240 determines that a missing column is present (YES in step S715), the sequence moves to step S716, whereas if a missing column is not present (NO in step S715), the sequence moves to step S717.

(S716) Anomaly determiner 240 performs missing column obtainment processing, which is processing for obtaining the missing column. If a missing column is present, an anomaly determination cannot be made for all of the determination target columns indicated in the anomaly determination rule. For example, if “ip_dst” is the missing column, for anomaly determiner 240 to make anomaly determinations for all the determination target columns indicated in the anomaly determination rule “model-03”, it is necessary for anomaly determiner 240 to obtain the “ip_dst” column, which is the missing column, and make the anomaly determination again. Accordingly, anomaly determiner 240 performs the missing column obtainment processing to obtain the missing column. The missing column obtainment processing will be described later. Anomaly determiner 240 obtains log 501 including the missing column through the missing column obtainment processing, and returns to the processing of step S713 to make the anomaly determination again including the missing column included in log 501 obtained.

(S717) Outputter 260 outputs information indicating the result of the anomaly determination for log 501 matching the anomaly determination rule in the anomaly determination in step S713 (also simply called an “anomaly determination result”) as alert 701. Alert 701 may be displayed on a display device such as a display provided in log analysis system 400 (e.g., a display device provided in outputter 260, if outputter 260 is a UI), may be displayed on a display device provided in a computer or mobile terminal used by SOC analyst 900, or may be communicated to SOC analyst 900 using a tool such as email.

(S718) Log storage 220 stores log 501 received in step S711. The stored information of log 501 (also simply called “log information”) is used, for example, when anomaly determiner 240 makes an anomaly determination using an anomaly determination rule aside from the anomaly determination rule used in the anomaly determination in step S713, when log priority calculation device 300 determines the log priority, or when SOC analyst 900 performs analysis.

(S719) Determination result storage 210 stores the anomaly determination result and ends the anomaly determination processing.

A specific example of anomaly determination results will be described here.

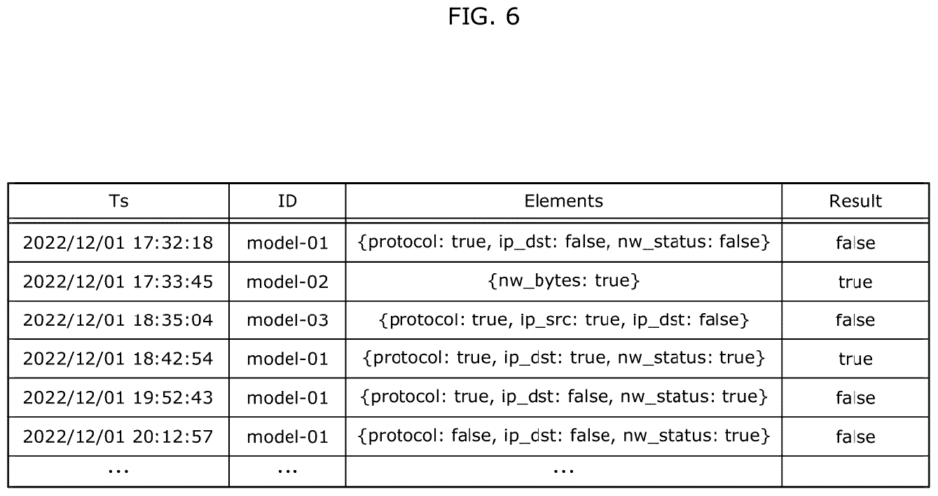

FIG. 6 is a diagram illustrating an example of anomaly determination results according to the present embodiment.

The anomaly determination result is a result of the anomaly determination for each of the one or more logs 501 received. In FIG. 6, each anomaly determination result includes “Ts”, “ID”, “Elements”, and “Result”.

“Ts” indicates the date/time when the anomaly determination based on the anomaly determination rule was made for log 501.

“ID” indicates the ID of the anomaly determination rule used in the anomaly determination.

“Elements” indicates a determination result (specifically, a determination result of the first determination) for each column under the determination condition indicated by the anomaly determination rule (specifically, the first condition). For example, “true” indicates that the value of the corresponding column satisfies the first condition. On the other hand, “false”, for example, indicates that the value of the corresponding column does not satisfy the first condition.

“Result” indicates a determination result as to whether log 501 matches the anomaly determination rule (i.e., a determination result of the second determination), i.e., a determination result for the anomaly determination rule as a whole.

Although the anomaly determination results illustrated in FIG. 6 are all anomaly determination results for log 501 having a log type of “device_com_log”, the anomaly determination results for logs 501 of other log types may be included.

For example, FIG. 6 illustrates that, as an anomaly determination result where “Ts” is “2022/12/01 17:32:18” and the ID is “model-01”, “Elements” indicating the determination result of the first determination are “protocol: true”, “ip_dst: false”, and “nw_status: false”, and “Result” indicating the determination result of the second determination is “false”. In other words, the result indicates that log 501 subject to this anomaly determination matched the first condition indicated in the anomaly determination rule having an ID of “model-01” and “protocol”, but did not match “ip_dst” and “nw_status”, and was therefore determined not to match the anomaly determination rule.

Additionally, in FIG. 6, as an anomaly determination result where “Ts” is “2022/12/01 18:42:54” and the ID is “model-01”, “Result” is “true”. This indicates that the number of logs 501 determined to match the anomaly determination rule “model-01”, i.e., matching all of the determination conditions indicated in the anomaly determination rule “model-01”, exceeded the threshold within the aggregation period. In other words, this indicates that the number of logs 501 satisfying the first condition indicated in the anomaly determination rule “model-01” satisfies the second condition.

Although not shown, if the number of logs 501 matching all of the determination conditions indicated in a given anomaly determination rule does not exceed the threshold within the aggregation period, even if all of the determination results for each column in the anomaly determination result are “true”, “Result” will be “false”.

Additionally, in the present embodiment, if a plurality of anomaly determination rules are present, anomaly determination is performed for all anomaly determination rules in step S713 in parallel or in order. However, the configuration is not limited thereto. For example, anomaly detection device 200 may make the anomaly determination for only some of the anomaly determination rules in step S713, and repeat the anomaly determination processing multiple times until an anomaly determination is made for all anomaly determination rules. If the anomaly determination processing is repeatedly executed, in step S711, anomaly determiner 240 obtains, from log storage 220, log 501 for which the anomaly determination for all anomaly determination rules is incomplete, and performs the anomaly determination in step S713 for log 501 obtained. This makes it possible to reduce the resources of anomaly detection device 200 required to execute a single instance of the anomaly determination processing. Additionally, if an anomaly determination rule other than the anomaly determination rule used in the anomaly determination in step S713 is added, for example, an anomaly determination may be made for the added anomaly determination rule as well.

Additionally, in the present embodiment, anomaly determiner 240 performs the anomaly determination for one or more logs 501 stored in log storage 220 for a predetermined period, but the configuration is not limited thereto. For example, anomaly determiner 240 may directly obtain logs 501 received by communicator 250 and make the anomaly determinations for each log 501 in sequence. This makes it possible for anomaly detection device 200 to execute anomaly determinations in real time for logs 501 received.

The missing column obtainment processing will be described next.

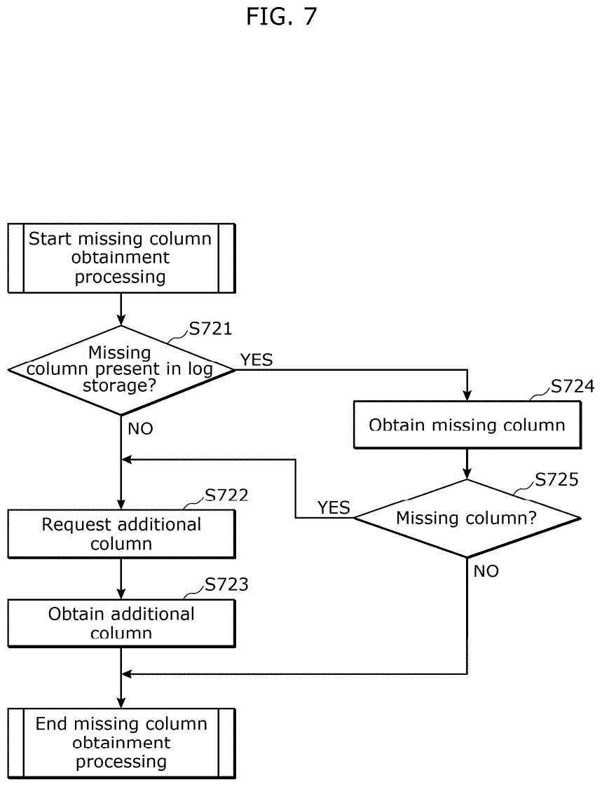

FIG. 7 is a flowchart illustrating an example of the missing column obtainment processing in the anomaly determination processing executed by anomaly detection device 200 according to the present embodiment. Specifically, FIG. 7 is a flowchart illustrating details of the processing of step S716.

(S721) Anomaly determiner 240 determines whether the information of the missing column for which an anomaly determination is to be additionally made is present in log storage 220 included in anomaly detection device 200. Anomaly detection device 200 executes step S724 if the information of the missing column is present in log storage 220 (YES in step S721), and executes step S722 if the information of the missing column is not present in log storage 220 (NO in step S721).

Here, the information of the missing column being present in log storage 220 corresponds to a case where, for example, log 501 including the missing column was stored in log storage 220 during a previous instance of the missing column obtainment processing. For example, there are situations where when the anomaly determination for the plurality of anomaly determination rules is executed by anomaly detection device 200 in parallel or in order in step S713, a specific same column becomes a missing column multiple times. In the example in FIG. 5, if the “ip_dst” column becomes the missing column in the anomaly determination for the anomaly determination rule having an ID of “model-01”, the column may also become the missing column in the anomaly determination for the anomaly determination rule having an ID of “model-03”. In such a case, it is assumed that the missing column obtainment processing was executed once, and log 501 including the missing column (here, the “ip_dst” column) was obtained from device group 120 and stored in log storage 220. In such a case, in the subsequent missing column obtainment processing, anomaly detection device 200 can obtain information of the missing column from log storage 220 without sending additional log request 502 to device group 120.

(S722) Communicator 250 requests an additional column (i.e., the missing column) from device group 120 at site 110 to obtain the missing column. Specifically, communicator 250 sends additional log request 502 to device group 120. Additional log request 502 is information including “uid”, which is the log identifier, and the column name of the missing column for log 501 having the missing column. Having received additional log request 502, device group 120 sends log 501, including information on the missing column indicated by the column name included in additional log request 502, to anomaly detection device 200.

(S723) Communicator 250 receives log 501 including the additional column (i.e., the missing column) sent from device group 120 in response to additional log request 502, and communicates log 501 received to anomaly determiner 240. Communicator 250 also stores log 501 including the missing column in log storage 220, and ends the missing column obtainment processing.

(S724) Anomaly determiner 240 searches out and obtains log 501 having “uid” matching log 501 having the missing column from among the plurality of logs 501 stored in log storage 220, i.e., log 501 including the missing column.

(S725) Anomaly determiner 240 determines whether the information of all missing columns is included in log 501 obtained in step S724. If anomaly determiner 240 determines that the information of all missing columns is not included and a missing column remains (YES in step S725), the sequence moves to step S722. However, if anomaly determiner 240 determines that the information of all the missing columns is included in log 501 obtained in step S724 and no missing column remains (NO in step S725), the missing column obtainment processing is ended.

Log priority update processing executed by log priority calculation device 300 will be described next. The log priority update processing is processing executed periodically, e.g., about once a day. The frequency at which the log priority update processing is executed may be set by SOC analyst 900 or the like as appropriate in accordance with the environment of site 110 being monitored or the environment of log analysis system 400.

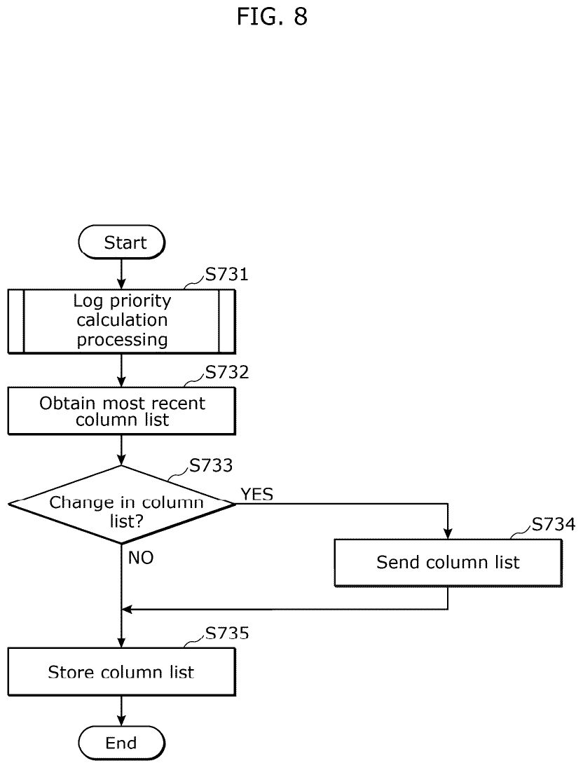

FIG. 8 is a flowchart illustrating an example of the log priority update processing according to the present embodiment.

(S731) Log priority calculation device 300 generates column list 601 by performing log priority calculation processing. Log priority calculation device 300 determines the log priority based on, for example, anomaly determination rules for each log type obtained from anomaly detection device 200 and anomaly determination results or log information for each log type, and generates column list 601 indicating the determined log priority by executing the log priority calculation processing (described later). For example, column list 601 for log 501 of the log type indicated by “device_com_log” is generated based on an anomaly determination rule having a “Type” of “device_com_log” and an anomaly determination result or log information of log 501 of that log type.

The log priority and column list 601 will be described in detail here. The log priority indicates, for example, a degree for determining a column to be included in log 501 from among the columns included in a communication log indicating a communication result between devices that may be included in log 501 of a given log type. Column list 601 is generated for each log type, for example. Device group 120 at site 110 selects a column to be sent in log 501 of each log type according to the log priority included in column list 601, and sends log 501 of each log type including the selected column to anomaly detection device 200.

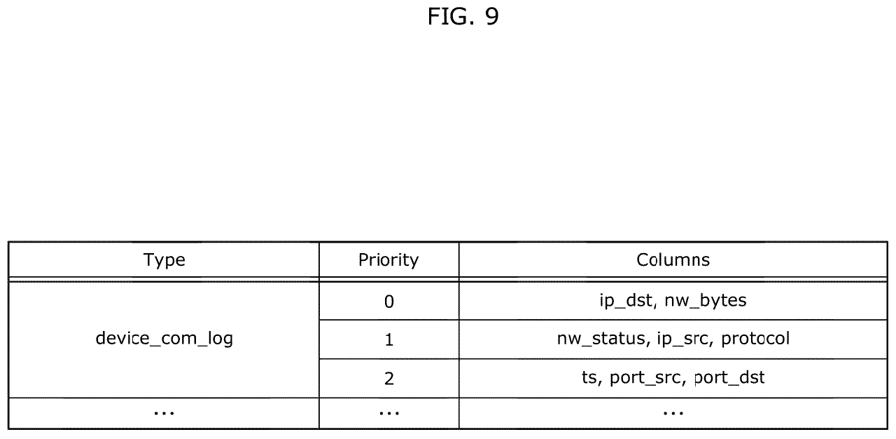

FIG. 9 is a diagram illustrating an example of column list 601 stored in log priority storage 330 according to the present embodiment.

In FIG. 9, column list 601 includes “Type”, indicating the log type, “Priority”, indicating the log priority for each column, and “Columns”, indicating each column. The log priority for each column indicated in “Priority” indicates that device group 120 is to include the column with which that log priority is associated in log 501 preferentially as the value decreases. At least some value for “Priority” is assigned to each column.

For example, FIG. 9 indicates that for log 501 of a log type indicated by a “Type” of “device_com_log”, the “ip_dst” and “nw_bytes” columns, which have a minimum Priority, i.e., 0, are columns to be included in log 501 of that log type with the highest priority, i.e., that log 501 is a first priority log.

Meanwhile, the “nw_status”, “ip_src”, and “protocol” columns, which have a “Priority” of 1 (1 greater than 0), are columns to be included in log 501 of that log type with the next-highest priority after the first priority log, i.e., that log 501 is a second priority log.

Furthermore, the “ts”, “port_src”, and “port_dst” columns, which have a “Priority” of 2 (1 greater than 1), are columns to be included in log 501 of that log type with the next-highest priority after the second priority log, i.e., that log 501 is a third priority log.

Note that the “Priority” indicating the log priority is not limited thereto, and may at least be indicated by a two-level value indicating a column that is absolutely required to be included in log 501 and a column that need not be included in log 501. In the present embodiment, the first priority log is a column that is at least to be included in log 501. Additionally, the column may be included in log 501 with a higher priority as the value of “Priority” increases instead. Additionally, an upper limit value for the number of columns to be included in log 501 may be determined in advance as desired, or an amount of data to be included in log 501 may be determined in advance as desired.

The descriptions will return to the log priority update processing illustrated in FIG. 8.

(S732) Log priority determiner 320 obtains the most recent column list 601 among past column lists 601 stored in log priority storage 330. The most recent column list 601 is column list 601 stored as a result of the previous instance of the log priority update processing.

(S733) Log priority determiner 320 compares column list 601 generated in step S731 with column list 601 obtained in step S732, and determines whether a change in the log priority has occurred for each column included in column list 601. For example, if the “Priority” indicating the log priority of “nw_status” included in log 501 having a log type of “device_com_log” was 0 in the most recent column list 601 and 1 in column list 601 generated in step S731, the log priority is determined to have changed. If the log priority has changed (YES in step S733), log priority calculation device 300 moves to the processing of step S734, whereas if the log priority has not changed (NO in step S733), log priority calculation device 300 moves to the processing of step S735.

(S734) Outputter 340 obtains column list 601 generated in step S731 from log priority determiner 320, and outputs column list 601 obtained to device group 120 at site 110.

Note that outputter 340 may output column list 601 generated in step S731 to device group 120 as-is, or may output only the difference between column list 601 generated in step S731 and column list 601 obtained in step S732 to device group 120.

(S735) Log priority storage 330 stores column list 601 generated in step S731, and ends the log priority update processing.

Note that in the present embodiment, in the log priority update processing, log priority calculation device 300 first generates column list 601 and then outputs column list 601 generated to device group 120 at site 110 when the log priority for each column changes. However, the configuration is not limited thereto. For example, in step S731, log priority calculation device 300 may generate column list 601 by performing the log priority calculation processing if any of the anomaly determination rules for each log type obtained from anomaly detection device 200 has changed from the anomaly determination rules obtained in the past. As a result, log priority calculation device 300 performs the log priority calculation processing only when any one of the anomaly determination rules changes, and thus the resources required by log priority calculation device 300 can be reduced.

The log priority calculation processing will be described next.

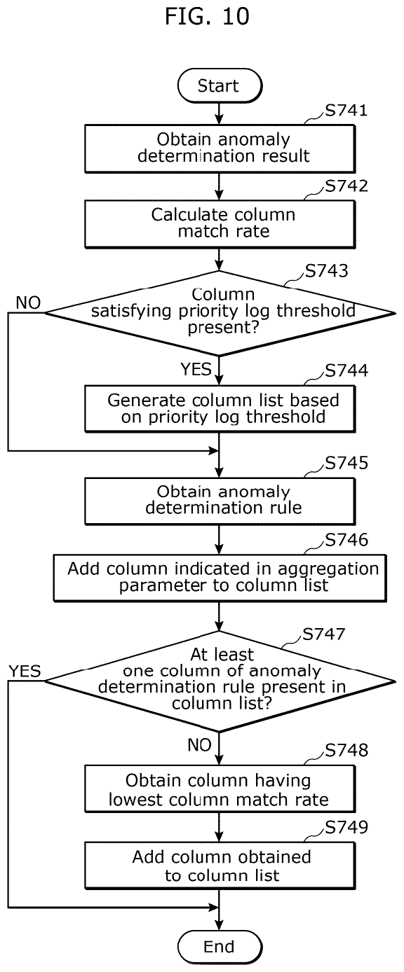

FIG. 10 is a flowchart illustrating an example of the log priority calculation processing according to the present embodiment. Specifically, FIG. 10 is a flowchart illustrating an example of the details of the processing of step S731. In the example illustrated in FIG. 10, log priority calculation device 300 determines the log priority for each log type using the result of the anomaly determination made by anomaly determiner 240 in step S713, i.e., using the anomaly determination result, and generates and outputs column list 601 for each log type.

(S741) Anomaly detection information obtainer 310 obtains the anomaly determination result illustrated in FIG. 6, for example, from anomaly detection device 200 (and specifically, from determination result storage 210) as an anomaly determination result for log 501 of a desired log type from a past predetermined period, and sends the anomaly determination result obtained to log priority determiner 320. As described above, all of the anomaly determination results illustrated in FIG. 6 are anomaly determination results for log 501 having a log type of “device_com_log”.

(S742) Log priority determiner 320 calculates a column match rate of each column for each anomaly determination rule indicated by the ID of the anomaly determination result, based on the determination result for each column indicated by “Elements” in the anomaly determination result obtained in step S741. The column match rate is the ratio of the number of cases where a single column matches the condition indicated by the anomaly determination rule (a “true” number) to the number of determination results obtained for a single anomaly determination rule (a target anomaly determination rule). Specifically, the column match rate for each column is calculated for each anomaly determination rule according to the following Formula (1). In the present embodiment, the column match rate corresponds to a “matching rate”.

$$Column match rate ( \% ) = \frac{( \begin{matrix}number of true determination results for \\ determination target column\end{matrix} )}{( \begin{matrix}number of obtained determination results \\ for target anomaly determination rule\end{matrix} )} \qquad ( 1 )$$

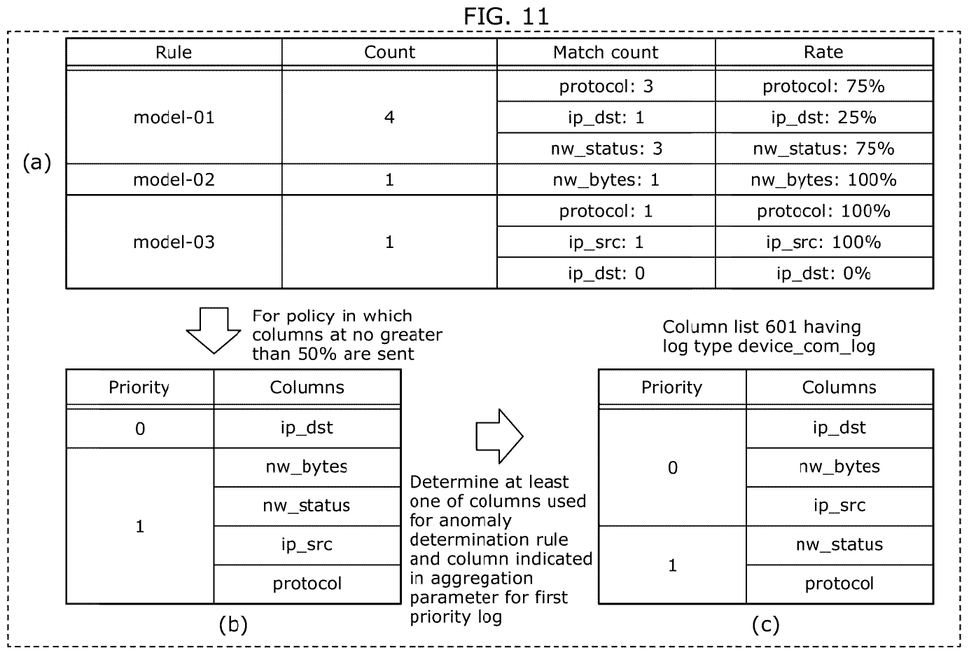

FIG. 11 is a diagram illustrating an example of a log priority determination process using an anomaly determination result according to the present embodiment. Specifically, FIG. 11 illustrates a process for determining the log priority for each column and a process for generating column list 601 when the column match rate is calculated based on the anomaly determination result illustrated in FIG. 6. Note that (a) in FIG. 11 is a diagram illustrating an example of the column match rate, (b) in FIG. 11 is a diagram illustrating an example of the log priority calculated from the column match rate, and (c) in FIG. 11 is a diagram illustrating column list 601 indicating the log priority determined again based on the log priority calculated from the column match rate and the anomaly determination rule.

A calculation result for the column match rate illustrated in FIG. 11 includes “Rule”, “Count”, “Match count”, and “Rate”, for example.

“Rule” indicates an ID of the anomaly determination rule.

“Count” indicates the number of determination results obtained according to each anomaly determination rule included in the anomaly determination result.

“Match count” indicates the number of cases where the determination result according to each anomaly determination rule for each column matches the condition, i.e., the number of cases where the determination result is “true”.

“Rate” indicates the column match rate for each column.

As illustrated in (a) of FIG. 11, the anomaly determination result illustrated in FIG. 6 includes four determination results according to the anomaly determination rule having an ID of “model-01”. In these four determination results, the number of determination results matching the condition (“Condition”), i.e., the number of determination results that are “true”, is 3 for “protocol”, 1 for “ip_dst”, and 3 for “nw_status” in the columns. Accordingly, when the column match rate for each column is calculated using the foregoing Formula (1), the rate is 75% for “protocol” (3/4=0.75), 25% for “ip_dst” (1/4=0.25), and 75% for “nw_status” (3/4=0.75).

Similarly, for the “Rule” of “model-02”, “Count” is 1 and “Match count” is 1 for “nw_bytes”, and thus the column match rate for “nw_bytes” is 100% (1/1=1).

For the “Rule” of “model-03”, “Count” is 1 and “Match count” is 1 for “protocol”, 1 for “ip_src”, and 0 for “ip_dst”, and thus the column match rate for each column is 100% for “protocol”, 100% for “ip_src”, and 0% for “ip_dst”.

(S743) Log priority determiner 320 determines, based on the column match rate for each column of all anomaly determination rules calculated in step S742, whether a column that satisfies a predefined condition (a priority log threshold) as a policy is present.

For example, if the condition for the column match rate is set to no greater than 50%, i.e., if a policy for sending columns having a column match rate of no greater than 50% is set in advance, “ip_dst” satisfies the condition of no greater than 50% because the column match rate is 25% for “model-01” and 0% for “model-03”, as illustrated in (a) of FIG. 11. Accordingly, in this case, log priority determiner 320 determines that a column that satisfies the condition is present. Log priority calculation device 300 moves to the processing of step S744 if, as a result of the determination made in this manner, a column satisfying the condition is present (YES in step S743), and to the processing of step S745 if a column satisfying the condition is not present (NO in step S743).

Note that the condition for the column match rate is not limited to a single condition, and a plurality of conditions may be set. If a plurality of conditions are set, log priority calculation device 300 determines, for example, that a column that satisfies the condition is present when a column that satisfies any of the conditions is present. The condition may also be a predetermined number of columns (e.g., 2) having a low column match rate.

(S744) Log priority determiner 320 determines the log priority for each column based on the condition, and generates column list 601. In the present embodiment, log priority determiner 320 determines the log priority taking the column that satisfies the condition, i.e., the column having a column match rate that meets the priority log threshold (a first priority threshold), that is, the column having a column match rate of no greater than the priority log threshold, as the first priority log having a “Priority” of 0, and taking the column that does not satisfy the condition as the second priority log having a “Priority” of 1, and generates column list 601. In the example illustrated in (b) of FIG. 11, the first priority log (“Priority”: 0) is “ip_dst”, and the second priority log (“Priority”: 1) is “nw_bytes”, “nw_status”, “ip_src”, and “protocol”. Note that when a plurality of conditions are present, two or more “Priorities” are set, and a plurality of priority logs after the third priority log may be present.

(S745) Log priority determiner 320 obtains the anomaly determination rule. Specifically, log priority determiner 320 obtains an anomaly determination rule (and specifically, information indicating the anomaly determination rule), among the one or more anomaly determination rules used in the anomaly determination in step S713, for which the log type indicated by “Type” is the same as the log type for which column list 601 is to be generated, from anomaly detection device 200 (and specifically, from rule storage 230) via anomaly detection information obtainer 310. In the present embodiment, three anomaly determination rules are obtained, namely “model-01”, “model-02”, and “model-03”, for which “Type” indicates the log type is “device_com_log”.

(S746) Log priority determiner 320 adds the column indicated as the aggregation parameter in the anomaly determination rule obtained in step S745 to column list 601 generated in step S744 as the first priority log, i.e., the log for which “Priority” indicating the log priority is 0. Note that if a column added to the first priority log is included in column list 601 as a column in a log aside from the first priority log, the entry for that column may be deleted. In the present embodiment, the anomaly determination rules obtained in step S745 are the anomaly determination rules “model-01”, “model-02”, and “model-03”. Of these anomaly determination rules, the “ip_src” column is indicated as an aggregation parameter in the anomaly determination rules “model-01” and “model-02”. Accordingly, log priority determiner 320 adds the “ip_src” column as the first priority log to column list 601. Note that in the present embodiment, if an aggregation parameter is set in the anomaly determination rule, the aggregation parameter corresponds to an item required for the anomaly determination. For example, log priority determiner 320 determines the log priority to be a degree to which device group 120 is to include, in log 501, an item required for the anomaly determination, included in each of the one or more anomaly determination rules used by anomaly detection device 200. As described above, anomaly detection device 200 classifies (aggregates) a plurality of logs 501 into a plurality of groups using aggregation parameters (predetermined items), and performs the anomaly determination for each of the groups. Accordingly, for example, log priority determiner 320 determines the priority to be a degree indicating that device group 120 is to include the log priority of the aggregation parameter in log 501.

(S747) Log priority determiner 320 determines, by verifying the determination target columns (e.g., the aggregation parameters) defined in the anomaly determination rule obtained in step S745 against column list 601 generated in step S744, whether at least one column among the determination target columns of each anomaly determination rule is included in the first priority log in column list 601 generated. If log priority determiner 320 determines that at least one determination target column of each anomaly determination rule is included in the first priority log in column list 601 generated (YES in step S747), the log priority calculation processing is ended, whereas if a determination target column is not included (NO in step S747), the sequence moves to step S748.

For example, in the example illustrated in FIG. 11, the determination target columns for the anomaly determination rule “model-01” are “Protocol”, “ip_dst”, and “nw_status”. Here, because the first priority log in column list 601 includes “ip_dst”, log priority determiner 320 determines that at least one determination target column of the anomaly determination rule is included in the first priority log in column list 601 generated. On the other hand, the determination target column for the anomaly determination rule “model-02” is “nw_bytes”. Here, because the first priority log in column list 601 does not include “nw_bytes”, log priority determiner 320 determines that a determination target column of the anomaly determination rule is not included in the first priority log in column list 601 generated.

(S748) Log priority determiner 320 obtains the column having the lowest column match rate from among the determination target columns indicated by the anomaly determination rule according to which, in step S747, the determination target column was determined not to be included in the first priority log in column list 601 generated. If, for example, a plurality of columns having the lowest column match rate are present, log priority determiner 320 obtains any one of those columns. For example, in the example illustrated in FIG. 11, it is determined in step S747 that none of the determination target columns of the anomaly determination rule “model-02” is included in the first priority log. Accordingly, log priority determiner 320 selects and obtains the column having the lowest column match rate, namely “nw_bytes”, among the determination target columns of the anomaly determination rule “model-02”.

(S749) Log priority determiner 320 adds the column obtained in step S748 to the first priority log in column list 601 generated in step S744, i.e., as a column for which “Priority”, indicating the log priority, is 0. The log priority calculation processing then ends.

Note that if a column added to the first priority log is included in column list 601 as a log aside from the first priority log, log priority determiner 320 may delete the entry for that column. For example, in the example illustrated in FIG. 11, the column “nw_bytes” is added as the first priority log, and the column “nw_bytes” indicated as the second priority log is deleted. Accordingly, as illustrated in (c) of FIG. 11, in column list 601 that is ultimately generated, the first priority log (“Priority”: 0) is “ip_dst”, “nw_bytes”, and “ip_src”, and the second priority log (“Priority”: 1) is “nw_status” and “protocol”.

### Effects of Embodiment

Log priority calculation device 300 according to the present embodiment determines the log priority periodically, generates column list 601, and outputs column list 601 to device group 120 at site 110, which enables device group 120 to include only columns, among the columns of information (device data) include logs internal to the devices (e.g., operation logs) and/or communication logs of communication between devices, that have a high priority in column list 601 in log 501 when sending log 501 to anomaly detection device 200. Additionally, if anomaly detection device 200 determines that a complete anomaly determination cannot be made using log 501 that includes only the high-priority columns, additional log request 502 is output to device group 120 to include an additional necessary column in log 501 when sending log 501. This makes it possible to make an anomaly determination for log 501 including only the minimum number of columns, even if all the columns that can be included are not included in log 501. Accordingly, the volume of log 501 sent by device group 120 to anomaly detection device 200 can be reduced, which makes it possible for anomaly detection device 200 to efficiently perform comprehensive analyses (anomaly determinations) while suppressing increases in analysis costs and strain on the communication bandwidth.

For example, the determination result of anomaly detection device 200 includes, for each of the one or more items (columns) included in the first log, one or more results of determining whether a predetermined condition included in each of the one or more anomaly determination rules used by anomaly detection device 200 is satisfied. Furthermore, in the priority determination, log priority calculation device 300 according to the present embodiment calculates, for example, a column match rate, which is a percentage of results among one or more results determined to satisfy a predetermined condition, for each of the one or more items, and determines the priority so that an item having a low matching rate among the one or more items has a higher degree indicating that the item is to be included in the first log. In other words, for each of one or more items, log priority calculation device 300 calculates the column match rate, which is the percentage of determination results, among a predetermined number of determination results for each of the one or more anomaly determination rules, for which each of one or more items satisfies the predetermined condition set by each of the one or more anomaly determination rules, and then determines the log priority such that the degree is higher for items having a lower column match rate.

In this manner, log priority calculation device 300 according to the present embodiment calculates the column match rate in accordance with the determination result of the anomaly determination obtained periodically, determines the log priority based on the column match rate, and generates and outputs column list 601. In other words, because a column having a low column match rate is preferentially included in log 501 and sent to anomaly detection device 200, anomaly detection device 200 can first make the anomaly determination for the column having a low column match rate.

Here, additional log request 502 may be sent when, as a result of the anomaly determination, the determination target column matches the condition indicated in the anomaly determination rule. The column match rate of the column being low indicates that the probability that the column matches the condition indicated in the anomaly determination rule is low. Accordingly, by first making an anomaly determination for a column having a low column match rate, the number of times additional log request 502 is sent can be reduced compared to a case where an anomaly determination for a column having a high column match rate is made first. As a result, by having log priority calculation device 300 generate column list 601 having determined an appropriate log priority according to the anomaly determination result that changes over time, and then output column list 601 to device group 120, the analysis accuracy can be maintained in anomaly detection device 200, and furthermore, the total volume of logs 501 send to anomaly detection device 200 can be reduced.

A variation on the processing of step S731 will be described next. The following descriptions of the variation will focus on the differences from the foregoing embodiment, and descriptions of configurations and processing sequences that are the same may be omitted or simplified.

### Variation 1 on Embodiment

### Processing Sequence

Log priority calculation processing according to Variation 1 on the present embodiment will be described next.

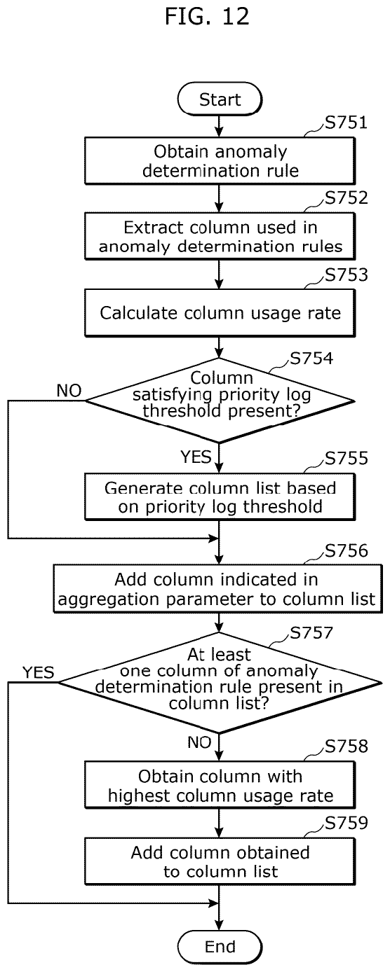

FIG. 12 is a flowchart illustrating an example of the log priority calculation processing according to Variation 1 on the present embodiment. Specifically, FIG. 12 illustrates another example of the details of the processing of step S731. In Variation 1 on the present embodiment, log priority calculation device 300 calculates a column usage rate for each log type based on the anomaly determination rules stored in rule storage 230, determines the log priority based on the column usage rate calculated, and generates and outputs column list 601 for each log type based on the determined log priority. In the present variation, the column usage rate corresponds to a usage rate.

(S751) Anomaly detection information obtainer 310 obtains the anomaly determination rules for log 501 of a given log type from anomaly detection device 200 (and specifically, from rule storage 230), and sends the anomaly determination rules to log priority determiner 320. The anomaly determination rules obtained are, for example, the anomaly determination rules indicated in FIG. 5. As described above, in the example of the anomaly determination rules in FIG. 5, all of the log types of logs 501 that are subject to anomaly determination are “device_com_log”.

(S752) Log priority determiner 320 extracts information about the determination target columns indicated by the anomaly determination rules obtained in step S751, i.e., the columns used for anomaly determination. Log priority determiner 320 then calculates, for each determination target column, a total number of anomaly determination rules including each determination target column.

For example, in FIG. 5, the determination target column is the column indicated with a condition in “Condition”. For example, the determination target columns for the anomaly determination rule having the ID “model-01” are “protocol”, “ip_dst”, and “nw_status”. The determination target column “protocol” is included in the anomaly determination rule “model-03” in addition to the anomaly determination rule “model-01”. Accordingly, the number of anomaly determination rules including the determination target column is calculated as 2.

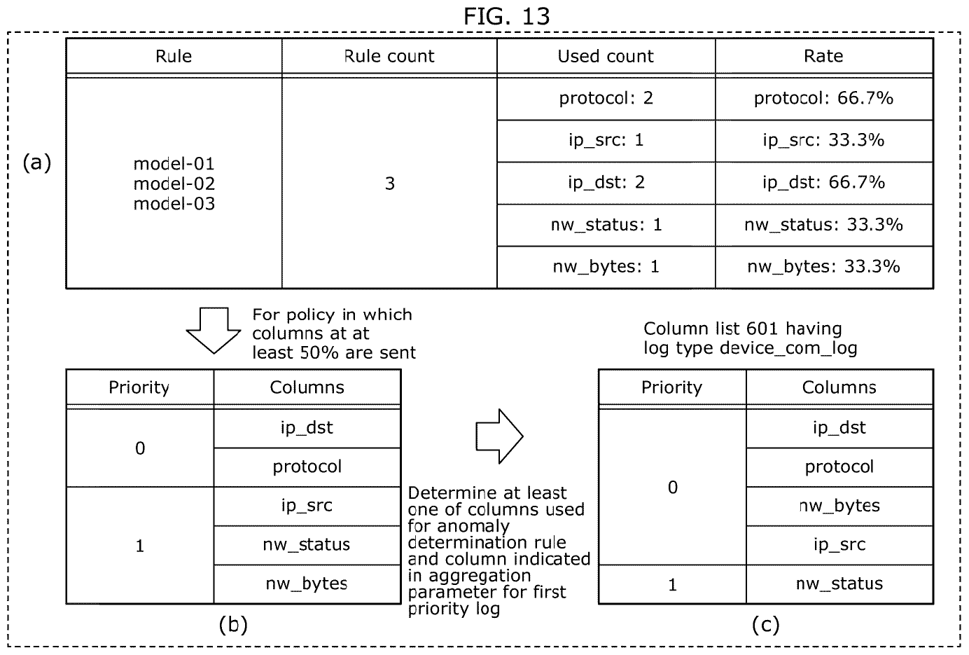

FIG. 13 is a diagram illustrating an example of a log priority determination process using anomaly determination rules according to Variation 1 on the present embodiment. Specifically, FIG. 13 illustrates a process for determining the log priority for each column and a process for generating column list 601 when the column usage rate is calculated based on the anomaly determination rules illustrated in FIG. 5. Note that (a) in FIG. 13 is a diagram illustrating an example of the column usage rate, (b) in FIG. 13 is a diagram illustrating an example of the log priority calculated from the column usage rate, and (c) in FIG. 13 is a diagram illustrating column list 601 indicating the log priority determined again based on the log priority calculated from the column usage rate and the anomaly determination rules.

A calculation result for the column usage rate illustrated in FIG. 13 includes “Rule”, “Rule Count”, “Used count”, and “Rate”, for example.

“Rule” indicates an ID of the obtained anomaly determination rule.

“Rule count” indicates the number of anomaly determination rules obtained.

“Used count” indicates the number of anomaly determination rules including each determination target column.

“Rate” indicates the column usage rate for each column. For example, the “Used count” for “Protocol”, which is an example of the determination target column in FIG. 13, is 2.

(S753) Log priority determiner 320 calculates the column usage rate for the anomaly determination rule based on the number of anomaly determination rules including each determination target column calculated in step S752 and the number of anomaly determination rules obtained. For example, the column usage rate is calculated through the following Formula (2).

$$Column usage rate ( \% ) = \frac{( \begin{matrix}number of anomaly determination rules \\ including determination target column\end{matrix} )}{( \begin{matrix}number of anomaly determination \\ rules obtained\end{matrix} )} \qquad ( 2 )$$

For example, in FIG. 13, the obtained anomaly determination rules indicated by “Rule” are the three rules “model-01”, “model-02”, and “model-03”, and “Rule count” is therefore 3. Accordingly, the column usage rate for each determination target column is calculated as 66.7% for “protocol” (2/3=0.667 . . . ), 33.3% for “ip_src” (1/3=0.333 . . . ), 66.7% for “ip_dst” (2/3=0.667 . . . ), 33.3% for “nw_status” (1/3=0.333 . . . ), and 33.3% for “nw_bytes” (1/3=0.333 . . . ).

(S754) Log priority determiner 320 determines, based on the column usage rate for each determination target column calculated in step S753, whether a column that satisfies a predefined condition (a priority log threshold) as a policy is present.

For example, if the condition for the column usage rate is set to at least 50%, i.e., if a policy for sending columns having a column usage rate of at least 50% is set in advance, “protocol” has a column usage rate of 66.7% and “ip_dst” has a column usage rate of 66.7% as indicated in (a) of FIG. 13, and thus the condition of the column usage rate being at least 50% is satisfied. Accordingly, in this case, log priority determiner 320 determines that a column that satisfies the condition is present. Log priority determiner 320 moves to the processing of step S755 if, as a result of the determination made in this manner, a column satisfying the condition is present (YES in step S754), and to the processing of step S756 if a column satisfying the condition is not present (NO in step S754).

Note that the condition for the column usage rate is not limited to a single condition, and a plurality of conditions may be set. If a plurality of conditions are set, log priority calculation device 300 determines, for example, that a column that satisfies the condition is present when a column that satisfies any of the conditions is present. The condition may also be a predetermined number of columns (e.g., 2) having a high column usage rate.

(S755) Log priority determiner 320 determines the log priority for each column based on the condition, and generates column list 601. In Variation 1 on the present embodiment, log priority determiner 320 determines the log priority taking the column that satisfies the condition, i.e., the column having a column usage rate that meets the priority log threshold (a second priority threshold), that is, the column having a column usage rate of at least the priority log threshold, as the first priority log having a “Priority” of 0, and taking the column that does not satisfy the condition as the second priority log having a “Priority” of 1, and generates column list 601.

In the example illustrated in (b) of FIG. 13, the first priority log (“Priority”: 0) is “ip_dst” and “protocol”, and the second priority log (“Priority”: 1) is “ip_src”, “nw_status”, and “nw_bytes”. Note that a plurality of conditions may be present, two or more “Priorities” may be set, and a plurality of priority logs after the third priority log may be present.

(S756) Log priority determiner 320 adds the column indicated as the aggregation parameter in the anomaly determination rule obtained in step S751 to column list 601 generated in step S755 as the first priority log, i.e., the log for which “Priority” indicating the log priority is 0. Note that if a column added to the first priority log is included in column list 601 as a column in a log aside from the first priority log, the entry for that column may be deleted. In the present embodiment, the anomaly determination rules obtained in step S751 are the anomaly determination rules “model-01”, “model-02”, and “model-03”, and of these anomaly determination rules, the “ip_src” column is indicated as an aggregation parameter in the anomaly determination rules “model-01” and “model-02”. Accordingly, log priority determiner 320 adds the “ip_src” column as the first priority log to column list 601. Note that in the present embodiment, if an aggregation parameter is set in the anomaly determination rule, the aggregation parameter corresponds to an item required for the anomaly determination.

(S757) Log priority determiner 320 determines, by verifying the determination target columns (e.g., the aggregation parameters) indicated in the anomaly determination rule obtained in step S752 against the column list generated in step S755, whether at least one column among the determination target columns of each anomaly determination rule is included in the first priority log in column list 601 generated. If log priority determiner 320 determines that at least one determination target column of each anomaly determination rule is included in the first priority log in column list 601 generated (YES in step S757), the log priority calculation processing is ended, whereas if not (NO in step S757), the sequence moves to step S758.

For example, the determination target columns for the anomaly determination rule “model-01” are “Protocol”, “ip_dst”, and “nw_status”, as illustrated in FIG. 5. Here, because the first priority log in column list 601 illustrated in FIG. 13 includes “ip_dst”, log priority determiner 320 determines that at least one determination target column of the anomaly determination rule is included in the first priority log in column list 601 generated. On the other hand, the determination target column for the anomaly determination rule “model-02” is “nw_bytes”, as illustrated in FIG. 5. Here, because the first priority log in column list 601 illustrated in FIG. 13 does not include “nw_bytes”, log priority determiner 320 determines that the determination target column of the anomaly determination rule is not included in the first priority login column list 601 generated.

(S758) Log priority determiner 320 obtains the column having the highest column usage rate from among the information of the determination target columns indicated by the anomaly determination rule according to which, in step S757, the determination target column was determined not to be included in the first priority log in column list 601 generated. If, for example, a plurality of columns having the highest column usage rate are present, log priority determiner 320 obtains any one of those columns. For example, in the example illustrated in FIG. 13, it is determined in step S757 that none of the determination target columns of the anomaly determination rule “model-02” is included in the first priority log. Accordingly, log priority determiner 320 selects and obtains the column having the highest column usage rate, namely “nw_bytes”, among the determination target columns of the anomaly determination rule “model-02”.

(S759) Log priority determiner 320 adds the column obtained in step S758 to the first priority log in column list 601 generated in step S755, i.e., as a column for which “Priority”, indicating the log priority, is 0. The log priority calculation processing then ends.

Note that if a column added to the first priority log is included in column list 601 as a log aside from the first priority log, log priority determiner 320 may delete the entry for that column. For example, in the example illustrated in FIG. 13, the column “nw_bytes” is added as the first priority log, and the column “nw_bytes” indicated as the second priority log is deleted. Accordingly, as illustrated in (c) of FIG. 13, in column list 601 that is ultimately generated, the first priority log (“Priority”: 0) is “ip_dst”, “protocol”, “nw_bytes”, and “ip_src”, and the second priority log is “nw_status”.

### Effects of Variation 1 on Embodiment

As described above, according to Variation 1 on the present embodiment, in the determination of the priority, log priority calculation device 300 calculates, for example, a usage rate, which is a percentage of anomaly determination rules, among the plurality of anomaly determination rules, in which each of a plurality of items are used, for each of the plurality of items, and determines the priority so that an item having a high usage rate among the plurality of items has a higher degree indicating that the item is to be included in the first log. In other words, log priority calculation device 300 according to Variation 1 of the present embodiment obtains a plurality of anomaly determination rules used by anomaly detection device 200, calculates the percentage of anomaly determination rules, among the plurality of anomaly determination rules obtained, used by each of the plurality of items (columns) included in the device data as the usage rate for each of the plurality of items, and determines the log priority so that the degree for an item having a high usage rate is high.

In this manner, log priority calculation device 300 according to Variation 1 of the present embodiment periodically obtains anomaly determination rules that change over time, calculates the column usage rate in accordance with the determination target columns indicated by the anomaly determination rules, determines the log priority based on the column usage rate, and generates and outputs column list 601.

Accordingly, device group 120 can preferentially include a column having a high column usage rate in log 501 when sending log 501 to anomaly detection device 200. If, in an anomaly determination, a missing column is present, i.e., if any of the determination target columns indicated by the anomaly determination rules is not included in log 501, anomaly detection device 200 may send additional log request 502.

Here, the column usage rate of the column included in log 501 being high means that the column is indicated as a determination target column in a greater number of anomaly determination rules. Accordingly, if log 501 includes a column having a high column usage rate, the overall occurrence of missing columns can be reduced compared to a case where log 501 includes a column having a low column usage rate, and thus the number of times additional log request 502 is sent can be reduced. As a result, by generating and outputting column list 601 including an appropriate log priority even when the anomaly determination rules have changed over time, the analysis accuracy can be maintained, and furthermore, the total volume of logs 501 send to anomaly detection device 200 can be reduced.

### Variation 2 on Embodiment

### Processing Sequence

The log priority calculation processing according to Variation 2 on the present embodiment will be described next.

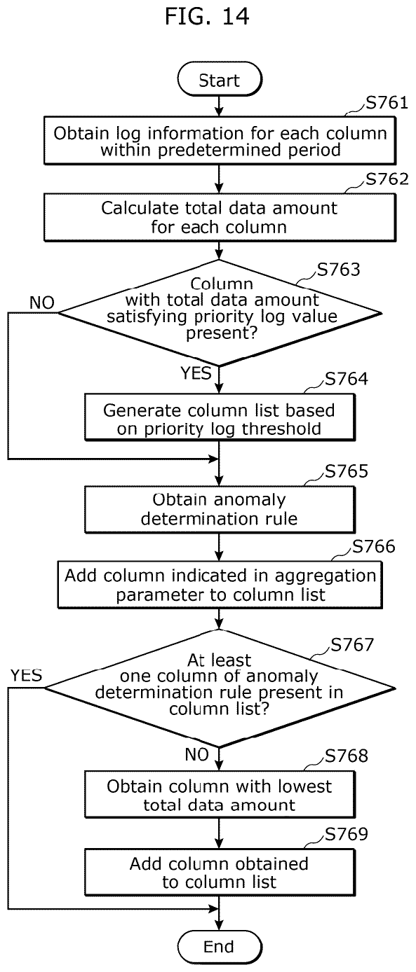

FIG. 14 is a flowchart illustrating an example of the log priority calculation processing according to Variation 2 on the present embodiment. In Variation 2 on the present embodiment, log priority calculation device 300 calculates the total data amount of the log in a predetermined period (a second period) for each log type, determines the log priority based on the total data amount of the log, and generates and outputs column list 601 for each log type. Specifically, log priority calculation device 300 calculates the total data amount for each column.

(S761) Log priority determiner 320 obtains log information for each column within the predetermined period. Specifically, anomaly detection information obtainer 310 obtains information about log 501 of any log type of device group 120 for a predetermined period, stored in log storage 220 of anomaly detection device 200, as the log information, and sends the log information to log priority determiner 320. For example, among logs 501 sent by device group 120 to anomaly detection device 200 within the predetermined period, anomaly detection information obtainer 310 obtains log 501 having the log type “device_com_log” from anomaly detection device 200, and sends that log 501 to log priority determiner 320.

The log information is, for example, information about log 501 stored in log storage 220. The log information may be any information used to calculate the total data amount for each column.

Note that the log information may be obtained from log storage 220, or may be obtained from device group 120 or a server or the like that manages the device data of device group 120. The log information obtained by anomaly detection information obtainer 310 is, for example, the information illustrated in FIG. 4. The logs obtained by log priority determiner 320 including such log information is an example of a second log.

The predetermined period may be set as desired, and is not particularly limited. For example, the predetermined period may be the period from when anomaly detection information obtainer 310 obtained the log information the previous time to when anomaly detection information obtainer 310 newly obtains the log information, and may be the previous 10 minutes, or the previous hour.

The log information obtained by anomaly detection information obtainer 310 may be information about log 501 including only some columns based on the log priority, or may be information about the device data of the IoT device including all columns.

(S762) Log priority determiner 320 calculates the total data amount for each column for the predetermined period from the log information obtained in step S761. The calculation of the total data amount is performed by a method such as data framing to obtain the amount of memory used for each column.

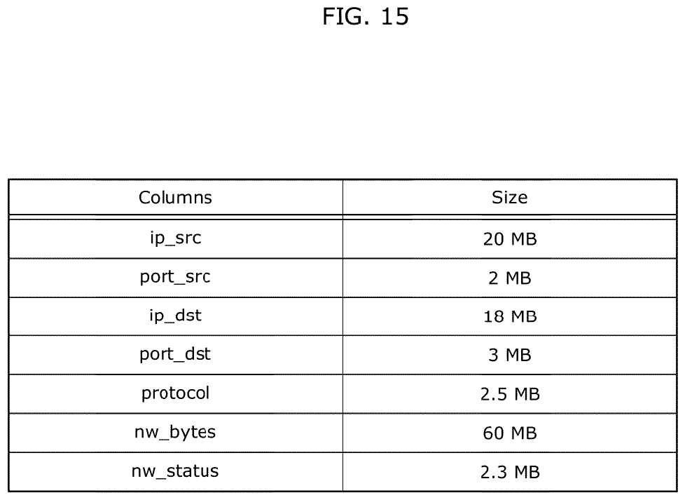

FIG. 15 is a diagram illustrating an example of a total data amount (total log volume) per column for a predetermined period according to Variation 2 on the present embodiment. Specifically, FIG. 15 illustrates an example of a calculation result for the total data amount per column for the predetermined period, calculated by log priority determiner 320. FIG. 15 illustrates the total data amount for each column (“Columns”) for the predetermined period, and for example, the total data amount for “ip_src” is 20 MB, and the total data amount for “port_src” is 2 MB.

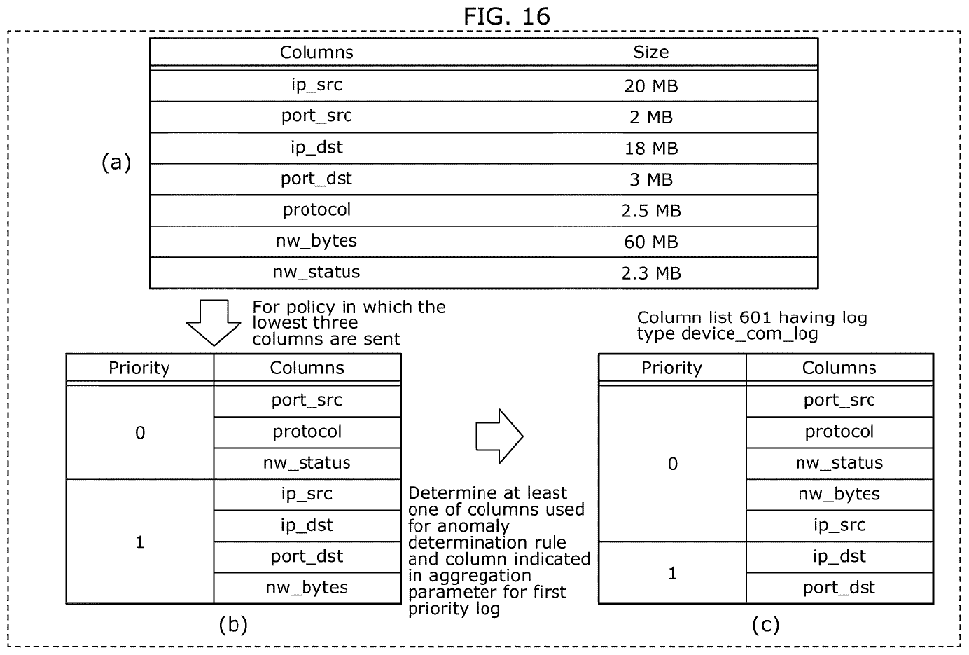

FIG. 16 is a diagram illustrating an example of a log priority determination process using the total data amount per column according to Variation 2 on the present embodiment. Specifically, FIG. 16 illustrates a process for determining the log priority for each column and a process for generating column list 601 when the total data amount for each column in the predetermined period is calculated as illustrated in FIG. 15. For example, the total data amount for each column is the total data amount for each column included in the device data recorded by device group 120 in the predetermined period, or the total data amount for each column included in log 501 sent by device group 120 in the predetermined period. Note that (a) in FIG. 16 is a diagram illustrating an example of the total data amount for each column, (b) in FIG. 16 is a diagram illustrating an example of the log priority calculated from the total data amount, and (c) in FIG. 16 is a diagram illustrating column list 601 indicating the log priority determined based on the log priority calculated from the total data amount and the anomaly determination rules.

(S763) Log priority determiner 320 determines, based on the total data amount for each column calculated in step S762, whether a column that satisfies a predefined condition (a priority log threshold) as a policy is present. The condition for the total data amount is set to, for example, no greater than 10 MB. In other words, the priority log threshold (a third priority threshold) is set as desired in advance, to 10 MB, for example.

Additionally, the first priority log may be a predetermined number of columns having the lowest total data amount (e.g., the bottom three).

For example, assume that the condition for the total data amount is no greater than 10 MB, and up to three columns having the lowest total data amounts are selected as the first priority log, i.e., the policy sends columns having a total data amount of no greater than 10 MB and up to three columns having the lowest total data amounts are sent. In this case, as illustrated in (a) of FIG. 16, the four columns “port_src”, “port_dst”, “protocol”, and “nw_status” satisfy the condition that the total data amount is no greater than 10 MB. Accordingly, in this case, log priority determiner 320 determines that a column that satisfies the condition is present. Log priority calculation device 300 moves to the processing of step S764 if, as a result of the determination made in this manner, a column satisfying the condition is present (YES in step S763), and to the processing of step S765 if a column satisfying the condition is not present (NO in step S763).

Note that the condition for the total data amount is not limited to a single condition, and a plurality of conditions may be set. If a plurality of conditions are set, log priority calculation device 300 determines, for example, that a column that satisfies the condition is present when a column that satisfies any of the conditions is present.

(S764) Log priority determiner 320 determines the log priority based on the condition, and generates column list 601. In Variation 2 on the present embodiment, log priority determiner 320 determines the log priority taking the column that satisfies the condition, i.e., the column having a total data amount that meets the priority log threshold (the third priority threshold), that is, the column having a total data amount of no greater than the priority log threshold, as the first priority log having a “Priority” of 0, and taking the column that does not satisfy the condition as the second priority log having a “Priority” of 1, and generates column list 601. Furthermore, in this example, if at least four first priority logs determined in this manner are present, up to three columns are selected as the first priority logs, in order from the log having the lowest total data amount. In the example illustrated in (b) of FIG. 16, when the three columns having the lowest total data amounts are used for the first priority logs, the first priority logs (“Priority”: 0) are “port_src”, “protocol”, and “nw_status”, and the second priority logs (“Priority”: 1) are “ip_src”, “ip_dst”, “port_dst”, and “nw_bytes”. Note that a plurality of conditions may be present, two or more “Priorities” may be set, and a plurality of priority logs after the third priority log may be present.

(S765) Log priority determiner 320 obtains the anomaly determination rule. Specifically, log priority determiner 320 obtains an anomaly determination rule (and specifically, information indicating the anomaly determination rule), among the one or more anomaly determination rules used in the anomaly determination in step S713, for which the log type indicated by “Type” is the same as the log type for which column list 601 is to be generated, i.e., the same as the log type of the log obtained in step S761, from anomaly detection device 200 (and specifically, from rule storage 230) via anomaly detection information obtainer 310. In this example, three anomaly determination rules are obtained, namely “model-01”, “model-02”, and “model-03”, for which “Type” indicates the log type is “device_com_log”.

(S766) Log priority determiner 320 adds the column indicated as the aggregation parameter in the anomaly determination rule obtained in step S765 to column list 601 generated in step S764 as the first priority log, i.e., the log for which “Priority” indicating the log priority is 0. Note that if a column added to the first priority log is included in column list 601 as a column in a log aside from the first priority log, the entry for that column may be deleted. In this example, the anomaly determination rules obtained in step S765 are the anomaly determination rules “model-01”, “model-02”, and “model-03”. Of these anomaly determination rules, the “ip_src” column is indicated as an aggregation parameter in the anomaly determination rules “model-01” and “model-02”. Accordingly, log priority determiner 320 adds the “ip_src” column as the first priority log to column list 601. Note that in this example, if an aggregation parameter is set in the anomaly determination rule, the aggregation parameter corresponds to an item required for the anomaly determination.

(S767) Log priority determiner 320 determines, by verifying the determination target columns (e.g., the aggregation parameters) indicated in the anomaly determination rule obtained in step S765 against column list 601 generated in step S764, whether at least one column among the determination target columns of each anomaly determination rule is included in the first priority log in column list 601 generated. If log priority determiner 320 determines that at least one determination target column of each anomaly determination rule is included in the first priority log in column list 601 generated (YES in step S767), the log priority calculation processing is ended, whereas if not (NO in step S767), the sequence moves to step S768.

For example, the determination target columns for the anomaly determination rule “model-01” are “Protocol”, “ip_dst”, and “nw_status”, as illustrated in FIG. 5. Here, because the first priority log in column list 601 illustrated in FIG. 16 includes “nw_status”, log priority determiner 320 determines that at least one determination target column of that anomaly determination rule is included in the first priority log in column list 601 generated. On the other hand, the determination target column for the anomaly determination rule “model-02” is “nw_bytes”, as illustrated in FIG. 5. Here, because the first priority log in column list 601 illustrated in FIG. 16 does not include “nw_bytes”, log priority determiner 320 determines that the determination target column of the anomaly determination rule is not included in the first priority login column list 601 generated.

(S768) Log priority determiner 320 obtains the column having the lowest total data amount from among the determination target columns indicated by the anomaly determination rule for which, in step S767, the determination target column was determined not to be included in the first priority log in column list 601 generated. If, for example, a plurality of columns having the lowest total data amount are present, log priority determiner 320 obtains any one of those columns. For example, in the example illustrated in FIG. 16, it is determined in step S767 that none of the determination target columns of the anomaly determination rule “model-02” is included in the first priority log. Accordingly, log priority determiner 320 selects and obtains the column having the lowest total data amount, namely “nw_bytes”, among the determination target columns of the anomaly determination rule “model-02”.

(S769) Log priority determiner 320 adds the column obtained in step S768 to the first priority log in column list 601 generated in step S764, i.e., as a column for which “Priority”, indicating the log priority, is 0. The log priority calculation processing then ends.

Note that if a column added to the first priority log is included in column list 601 as a log aside from the first priority log, log priority determiner 320 may delete the entry for that column. For example, in the example illustrated in FIG. 16, the column “nw_bytes” is added as the first priority log, and the column “nw_bytes” indicated as the second priority log is deleted. Accordingly, as illustrated in (c) of FIG. 16, in column list 601 that is ultimately generated, the first priority log (“Priority”: 0) is “port_src”, “protocol”, “nw_status”, and “nw_bytes”, and the second priority log is “ip_dst” and “port_dst”.

### Effects of Variation 2 on Embodiment

As described above, log priority calculation device 300 according to Variation 2 on the present embodiment obtains a second log including all the plurality of items every predetermined period (second period), for example, and in determining the priority, determines the priority based on the total amount of data in each of the plurality of items included in the second log obtained. Specifically, log priority calculation device 300 according to Variation 2 on the present embodiment obtains log 501 (or device data) that changes over time, calculates the total data amount in each column based on log 501 (or device data) for each predetermined period, determines the log priority based on the total data amount in each column, and generates and outputs column list 601. In other words, log priority calculation device 300 according to Variation 2 on the present embodiment obtains log 501 (or device data) for each predetermined period and determines the log priority based on the total amount of data in each of the plurality of items included in log 501 (or device data). For example, log 501 (or the device data) includes all of the plurality of items (columns) included in the device data recorded by device group 120.

Accordingly, device group 120 can preferentially include a column having a low total data amount in log 501 when sending log 501 to anomaly detection device 200. As a result, even if the trend or total data amount of log 501 (or device data) changes over time, column list 601 including an appropriate log priority can be generated and output to device group 120, which makes it possible to reduce the total volume of log 501 sent by device group 120 to anomaly detection device 200.

### Representative Example

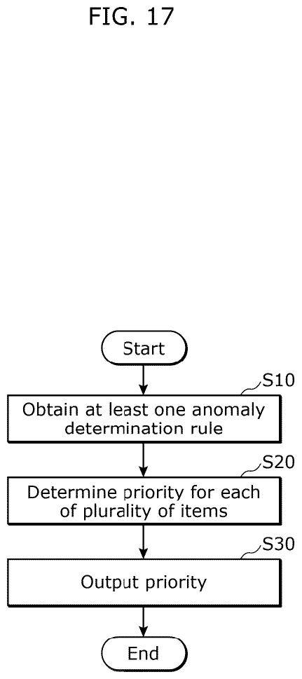

FIG. 17 is a flowchart illustrating an information processing method according to the present embodiment. The information processing method described below is performed, for example, by a processor of an information processing device, which includes the processor and a memory, using that memory. The information processing device is log priority calculation device 300, for example.

(S10) First, the information processing device obtains one or more anomaly determination rules to be used for anomaly determination for a log of a device. Each of the one or more anomaly determination rules includes a predetermined condition using one or more items among a plurality of items included in the log of the device. The device is, for example, a device included in device group 120.

(S20) The information processing device then determines a priority of each of the plurality of items based on the one or more anomaly determination rules obtained. The priority is a degree for determining an item, among the plurality of items, to be included in a first log to be sent to an analysis device that makes an anomaly determination.

The analysis device is anomaly detection device 200, for example.

The priority is “Priority” described above, for example.

The anomaly determination rule includes a predetermined condition for determining one or more items. In other words, the predetermined condition is a determination condition for determining the one or more items. The analysis device determines whether the log of the device is anomalous by determining whether the value of each of the one or more items satisfies the predetermined condition included in the anomaly determination rule. In other words, the analysis device determines whether an anomaly has occurred in the device based on the anomaly determination rule and the value corresponding to each of the one or more items.

(S30) The information processing device then outputs the determined priority.

For example, the information processing device sends the determined priority of the plurality of items to the device. Based on the priority received, the device determines one or more items to send to the analysis device from among the plurality of items stored as the log of the device. For example, the device determines the one or more items according to a predetermined rule according to the priority, such as an item for which the priority is at least a threshold or a predetermined number of items in order from the item having highest priority. The device sends a log (a first log) including the determined one or more items (specifically, a value corresponding to one or more items) to the analysis device. The analysis device determines (detects) whether an anomaly is present based on the one or more items included in the received first log (specifically, the value corresponding to the one or more items) and the one or more anomaly determination rules.

The determination result is communicated to a user, such as SOC analyst 900, or sent to the information processing device, for example. The information processing device re-determines the priority of each of the plurality of items based on the determination result received, for example. If, for example, the priority has changed, the information processing device sends the changed priority to the device. Based on the priority received, the device re-determines the one or more items to send to the analysis device.

By repeating such processing, the device can appropriately select an important item according to the priority when the analysis device is to make an anomaly determination, and send only the important item to the analysis device. Therefore, according to such an information processing method, the amount of data in a log sent to an analysis device can be reduced while maintaining the accuracy of log analysis by the analysis device.

Note that these comprehensive or specific aspects may be realized by a system, a method, an integrated circuit, a computer program, or a computer-readable non-transitory recording medium such as a CD-ROM, or may be implemented by any desired combination of systems, methods, integrated circuits, computer programs, and recording media.

For example, an information processing device according to one aspect of the present disclosure includes: an obtainer that obtains one or more anomaly determination rules to be used in an anomaly determination for a log of a device, each of the one or more anomaly determination rules including a predetermined condition using one or more items among a plurality of items included in the log of the device; a determiner that determines a priority of each of the plurality of items based on the one or more anomaly determination rules obtained, the priority being a degree for determining an item, among the plurality of items, to be included in a first log to be sent to an analysis device that performs the anomaly determination; and an outputter that outputs priorities, each being the priority determined.

The obtainer is anomaly detection information obtainer 310, for example. The obtainer executes step S10, for example.

The determiner is log priority determiner 320, for example. The determiner executes step S20, for example.

The outputter is outputter 340, for example. The outputter executes step S30, for example.

### OTHER EMBODIMENTS

An information processing device and the like according to the present disclosure have been described based on an embodiment and variations. However, the present disclosure is not limited to the foregoing embodiment and variations.

For example, the first period and the second period may be the same period (e.g., the same length of time and the same timing), or may be different periods. Additionally, the first priority threshold, the second priority threshold, and the third priority threshold may be the same value, or may be different values.

For example, the present disclosure may be realized by the methods described above. This may be a computer program that implements these methods on a computer, or a digital signal constituting the computer program. Additionally, aspects of the present disclosure may be realized as a computer program that causes a computer to execute the characteristic steps included in a log priority calculation method.

Additionally, the present disclosure may also be computer programs or digital signals recorded in a computer-readable recording medium such as a flexible disk, a hard disk, a CD-ROM, an MO, a DVD, a DVD-ROM, a DVD-RAM, a BD (Blu-ray (registered trademark) Disc), semiconductor memory, or the like. The constituent elements may also be the digital signals recorded in such a recording medium.

Additionally, the present disclosure may be realized by transmitting the computer program or digital signal via a telecommunication line, a wireless or wired communication line, a network such as the Internet, a data broadcast, or the like.

The orders in which the steps in the flowcharts are performed are for describing the present disclosure in detail, and other orders may be used instead. Some of the above-described steps may be executed simultaneously (in parallel) with other steps, and some of the above-described steps may not be executed.

Additionally, the divisions of the function blocks in the block diagrams are merely examples, and a plurality of function blocks may be realized as a single function block, a single function block may be divided into a plurality of function blocks, or some functions may be transferred to other function blocks. Additionally, the functions of a plurality of function blocks having similar functions may be processed by a single instance of hardware or software, in parallel or time-divided.

The above-described embodiments and variations may be combined as well. Variations on the embodiments conceived by one skilled in the art, embodiments implemented by combining constituent elements from different other embodiments, and the like may be included as well in the present disclosure as long as they do not depart from the essential spirit of the present disclosure.

### INDUSTRIAL APPLICABILITY

The present disclosure is useful in devices for reducing the volume of logs when sending logs associated with a device to an analysis device for anomaly analysis.

1. An information processing method executed by a computer, the information processing method comprising:
obtaining one or more anomaly determination rules to be used in an anomaly determination for a log of a device, each of the one or more anomaly determination rules including a predetermined condition using one or more items among a plurality of items included in the log of the device;
determining a priority of each of the plurality of items based on the one or more anomaly determination rules obtained, the priority being a degree for determining an item, among the plurality of items, to be included in a first log to be sent to an analysis device that performs the anomaly determination; and
outputting priorities, each being the priority determined.

2. The information processing method according to claim 1,
wherein the log of the device is a communication log of the device or an operation log of the device.

3. The information processing method according to claim 1, further comprising:
storing the priorities determined,
wherein the determining of the priorities is performed every predetermined first period, and
the outputting of the priorities includes outputting the priorities determined when any one of the priorities determined for the plurality of items has changed from a corresponding one of the priorities stored for the plurality of items.

4. The information processing method according to claim 3,
wherein the outputting of the priorities includes outputting only the priority, among the priorities determined for the plurality of items, of an item for which the priority has changed from the corresponding one of the priorities stored for the plurality of items.

5. The information processing method according to claim 1, further comprising:
storing the one or more anomaly determination rules obtained,
wherein the determining of the priorities is performed when at least one of the one or more anomaly determination rules obtained again has changed from the one or more anomaly determination rules stored.

6. The information processing method according to claim 1,
wherein the priority is one degree among at least two levels of degrees including a degree indicating that each of the plurality of items is to be included in the first log and a degree indicating that each of the plurality of items is not to be included in the first log.

7. The information processing method according to claim 6,
wherein the determining of the priority includes determining the priority to be a degree indicating that the priority of at least one item, among the one or more items used in the predetermined condition to be included in each of the one or more anomaly determination rules obtained, is to be included in the first log.

8. The information processing method according to claim 6,
wherein the analysis device classifies a plurality of first logs, each being the first log, into a plurality of groups using a predetermined item, and performs the anomaly determination for each of the plurality of groups, and
the determining of the priority includes determining the priority to be a degree indicating that the priority of the predetermined item is to be included in the first log.

9. The information processing method according to claim 1, further comprising:
obtaining a determination result of the anomaly determination for the first log, the anomaly determination being executed using the one or more anomaly determination rules,
wherein the determining of the priority includes determining the priority based on the determination result.

10. The information processing method according to claim 9,
wherein the determination result includes one or more results, each indicating whether the predetermined condition in a corresponding one of the one or more anomaly determination rules is satisfied, for each of the one or more items to be included in the first log, and
the determining of the priority includes:
calculating a matching rate for each of the one or more items, the matching rate being a percentage of the one or more results determined to satisfy the predetermined condition; and
determining the priority such that an item, among the one or more items, having a low matching rate has a high degree indicating the item is to be included in the first log.

11. The information processing method according to claim 1,
wherein the one or more anomaly determination rules are a plurality of anomaly determination rules, and
the determining of the priority includes:
calculating a usage rate for each of the plurality of items, the usage rate being a percentage of the plurality of anomaly determination rules using each of the plurality of items, and
determining the priority such that an item, among the plurality of items, having a high usage rate has a high degree indicating the item is to be included in the first log.

12. The information processing method according to claim 1, further comprising:
obtaining a second log including all of the plurality of items every predetermined second period,
wherein the determining of the priority includes determining the priority based on a total amount of data in each of the plurality of items included in the second log obtained.

13. An information processing device comprising:
an obtainer that obtains one or more anomaly determination rules to be used in an anomaly determination for a log of a device, each of the one or more anomaly determination rules including a predetermined condition using one or more items among a plurality of items included in the log of the device;
a determiner that determines a priority of each of the plurality of items based on the one or more anomaly determination rules obtained, the priority being a degree for determining an item, among the plurality of items, to be included in a first log to be sent to an analysis device that performs the anomaly determination; and
an outputter that outputs priorities, each being the priority determined.

14. A non-transitory computer-readable recording medium having recorded thereon a program for causing a computer to execute an information processing method, the information processing method comprising:
obtaining one or more anomaly determination rules to be used in an anomaly determination for a log of a device, each of the one or more anomaly determination rules including a predetermined condition using one or more items among a plurality of items included in the log of the device;
determining a priority of each of the plurality of items based on the one or more anomaly determination rules obtained, the priority being a degree for determining an item, among the plurality of items, to be included in a first log to be sent to an analysis device that performs the anomaly determination; and
outputting priorities, each being the priority determined.
